(19) United States
(12) Patent Application Publication
(10) Pub. No.: US 2026/0342419 A1
(43) Pub. Date: Oct. 29, 2026

(54) SCALABLE COMPRESSED SENSING BASED BEAM IDENTIFICATION

(71) Applicant: Telefonaktiebolaget LM Ericsson (publ), Stockholm (SE)

(72) Inventors: Tamas BORSOS, Budapest (HU); András RÁCZ, Budapest (HU); Mårten SUNDBERG, ÄRSTA (SE); Máté SZEBENYEI, Budapest (HU)

(73) Assignee: Telefonaktiebolaget LM Ericsson (publ), Stockholm (SE)

(21) Appl. No.: 19/124,183

(22) PCT Filed: Nov. 1, 2022
(86) PCT No.: PCT/SE2022/050999

§ 371 Date: Apr. 24, 2025

(51) Int. Cl. H04B 7/06; H04B 17/318

(52) U.S. Cl. CPC H04B 7/06952; H04B 17/328

(57) ABSTRACT

A method for compressed sensing based beam scanning by a UE in a network having a coverage area decomposed into sparse decoding (SD) areas, each comprising a sub-area smaller than the coverage area and having a corresponding dictionary. The UE synchronizes to a signal burst broadcasted by a set of access points in a SD area on all of a plurality of beams using varying beam power levels defined by respective dictionary descriptors, the signal burst comprising a number of broadcast signals and at least one dictionary descriptor defining a mapping between the SD area and a corresponding dictionary. A signal is measured using broadcasts signals. The dictionary descriptor is extracted. The synchronizing, measuring and extracting is repeated a designated number. A dictionary to use for SD is determined based on a determined dictionary descriptor. The UE optionally performs SD using the signal measurements and the dictionary.

The project leading to this application has received funding from the European Union's Horizon 2020 research and innovation program under grant agreement No 101015956.

### TECHNICAL FIELD

The present disclosure relates generally to communications, and more particularly to communication methods and related devices and nodes supporting wireless communications.

### BACKGROUND

In high frequency bands, radio signal propagation is suffering from large pathloss per distance and signals can get easily blocked by objects in the physical space, which altogether make the radio communication in these high frequency bands much more volatile and difficult as compared to lower bands. This is illustrated in FIG. 1 where the UE does not receive signals from all access points/base stations due to blockages and/or receives partially blocked signals. One solution to combat these problems is to direct the radio signal via beamforming in the direction where line of sight (LOS) or close to LOS propagation is possible.

Finding the best beam in all situations is a cornerstone of the beamforming problem, which can be divided into two main phases: (1) initial beam search and (2) beam tracking/update. At initial beam search when the UE has no connectivity to the network, it has to scan all possible beam directions to find the best one. For this purpose, the gNodeB transmits so called SSB (Synchronization Signal Blocks) signals, and the UE is doing a sweeping through the possible beams, measuring them all one-by-one. The UE scans for SSB signals, measures and selects the strongest beam direction. This can be a lengthy procedure and requires much transmit resources and time. If beamforming is available at the UE as well, this can multiply the possible beam combinations and associated scan time. The problem can become even more severe in Distributed massive MIMO (D-MIMO) settings where there are a large number of access points (APs) (typically more than UEs) each with a couple of transmit antennas and possible beam directions.

In the beam tracking problem, the best beam direction may need to be updated as it may change in time, e.g., as the user is moving or other users or objects are moving in the surrounding.

Independent of beamforming, the compressed sensing or compressive sensing (CS) theory is a relatively newly explored scheme, which has found its application in different areas more recently. For example, it has been successfully applied in imaging applications (e.g., in medical applications of MRI) or in radar signal processing.

Compressed sensing is a signal processing technique which says that if a signal is sparse in some domain, then the signal can be fully reconstructed from fewer number of measurement samples, than what would be required by sampling theory. Being sparse means that the signal contains a lot of zero elements when it is expressed in a certain domain or basis. For example, a signal can be sparse in the Fourier domain containing only a few non-zero Fourier components or an image can be sparse when transformed into the Discrete Fourier or Discrete Cosine Transform domain.

Explaining CS in an algebraic way, we can formulate the CS problem as solving an under determined set of linear equations. The setup is illustrated in FIG. 2. Vector \hat{X} is the sparse signal with dimension of N, vector Y is the measurement vector with dimension M, where M<<N and B is the measurement matrix. What is known is vector Y, i.e., the measurement samples and the measurement matrix B and we are interested in the signal \hat{X}. Since the number of equations (M) is less than the number of unknowns (N), the solution cannot be found with the classical linear equation solving.

Compressed sensing provides algorithms which can still solve these equations under the assumption that there are many zero elements in \hat{X}. These algorithms try to find the solution with the constrain that the L0 or L1 norm of vector \hat{X} is minimized.

Prior techniques to beam selection based at least on part of CS include the following.

“Low Latency Beam-Sweeping for Millimeter Wave Systems via Pessimistic Optimization”, A. S. Guerreiro; H. Iimori; K. Ishibash, describes reducing beam scanning time by design of a codebook with a limited number of beams.

“Optimal Beam-Sweeping and Communication in Mobile Millimeter-Wave Networks”, by N. Michelusi, M. Hussain describes tracking user location, which is used in a next beam association.

“Analysis of Beam Sweeping Techniques for Cell-Discovery in mm Wave Systems”, by P. Rashmi, A. Manoj, A. Pachai Kannu describes transmitting widened beams for a coarser scanning and hence reduces the number of beam combinations a UE has to go through.

“Comparative Performance Analysis of Beam Sweeping Using a Deep Neural Net and Random Starting Point in mmWave 5G New Radio”, A. Mazin, M. Elkourdi, and R. D. Gitli describes adapting a sweeping pattern based on call records (which leads to understanding where in the serving cell users are typically located and hence direct beams more often there to reduce connection time setup).

The above literature makes beam sweeping more efficient in different ways, but is not related to reducing beam sweeping time using CS.

“Compressed-Sensing based Beam Detection in 5G NR Initial Access”, by J. Sung and B. L. Evans describes using CS to estimate channel components assuming a sparse channel representation with N_{Cl}N_{ray} (a number of clusters times a number of rays) non-zero elements in a G_{BS}G_{UE} (a number of beams at a base station times a number of beams at a UE) sparse vector, and knowledge of signal transmitted, antenna response vectors at the base station and the UE and pre-coding weights. The focus is on hybrid beam forming for initial access in mmW communications.

“Compressive adaptation of large steerable arrays”, by D. Ramasamy; S. Venkateswaran; U. Madhow describes using CS to estimate channel parameters of channel gain and AoA, assuming sparsity due to number of paths are much smaller than the number of antenna elements.

The “Compressed-Sensing based Beam Detection in 5G NR Initial Access” and “Compressive adaptation of large steerable arrays” pose the estimation problem as a CS problem where the channel is expressed as sparse (spatial and/or temporal domain), relying on known signals to be transmitted for channel estimation and a CS algorithm is used to reconstruct channel coefficients.

There currently exist certain challenge(s). Existing beam sweeping procedures are quite resource consuming both in terms of the transmission of reference signals (e.g., SSB signals) and in terms of scanning time and resources at the UE. These procedures can introduce significant delay e.g., during the initial access procedure.

The beam sweeping problem becomes even more severe in Distributed massive MIMO systems, where there are a large number of distributed antennas with many potential beam combinations. Finding the best beam with a full scan in such a setting would be prohibitively complex and time consuming.

### SUMMARY

Various embodiments use CS for beam sweeping such that the best beam directions from all possible APs can be determined from a few transmissions without requiring a full scan search. The APs can transmit the same reference signal in all directions using the same time frequency resource and varying the transmit power allocations in a few combinations. The UE needs to measure only the composite received signal from all directions, it does not have to identify beams individually. The best beam direction(s) and corresponding channel gains can be determined using CS computation done either at the UE or at the network.

The required transmission combinations may be optimized to the particular environment by using machine learning. Thereby the required number of measurements can be significantly smaller as compared to applying the conventional CS algorithms.

According to some embodiments, a method for compressed sensing based beam scanning performed by a user equipment, UE, in a network having a coverage area of the network decomposed into a plurality of sparse decoding areas, each sparse decoding area comprising a sub-area smaller than the coverage area and having a corresponding dictionary assigned to the sparse decoding area, includes synchronizing to a broadcast signal burst broadcasted by a set of access points of the network in a sparse decoding area on all of a plurality of beams using varying beam power levels defined by respective dictionary descriptors, the signal block burst comprising a number of broadcast signals and comprising at least one dictionary descriptor defining a mapping between the sparse decoding area and a corresponding dictionary assigned to the sparse decoding area. The method includes measuring reference signal received power using the number of broadcasts signals. The method includes extracting the at least one dictionary descriptor. The method includes repeating the synchronizing, measuring and extracting for a designated number of times. The method includes responsive to the designated number of times being met, determining a dictionary descriptor to use. The method includes determining a dictionary to use for sparse decoding based on the determined dictionary descriptor.

UEs, computer programs, and computer program products are provided with analogous recitations.

Certain embodiments may provide one or more of the following technical advantage(s). Scalable beam selection solution for large areas is provided, where any UE position is covered only by a limited set of APs, with many overlapping APs and beams. Some embodiments are applicable for untrained (pseudo-) random dictionaries, and some for trained dictionaries with the described training methods. Smaller decoding complexity may be achieved due to smaller dictionaries applied. A decreased number of measurements may be required due to smaller dictionaries and scanning time can be significantly shortened. In some embodiments, parts of dictionaries may be reused between neighboring areas to reduce measurements, RS resources needed and scanning time. In some embodiments, a possibility is enabled to reuse radio resources allocated for transmitting CS beam combinations across the network.

According to some other embodiments, a method performed by a network node in a network includes configuring reference signal, RS, resources per access point, AP. The method includes determining a compressed sensing, CS, dictionary matrix. The method includes communicating which RS resources to measure on, including when to measure and how to report measurements to a user equipment, UE.

Network nodes, computer programs, and computer program products are provided with analogous recitations.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of beam scanning and tracking where some beams are blocked by objects;

FIG. 2 is an illustration of CS expressed as an undetermined set of linear equations;

FIG. 3 is an illustration of applying CS to beam scanning across a whole network;

FIG. 4 is an illustration of transmission of beam scanning reference signals;

FIG. 5 is a flow chart illustrating operations of a UE applying CS to beam scanning;

FIG. 6 is a flow chart illustrating operations of a network node applying CS to beam scanning;

FIG. 7 is an illustration of best beam indexing during test measurements along different routes according to some embodiments;

FIG. 8 an illustration of a number of beams with a signal strength>−100 dBm;

FIG. 9 is an illustration of a power allocation dictionary according to some embodiments;

FIGS. 10A and 10B are illustrations of estimated best beam directions with a number of measurement combinations set to 25 according to some embodiments;

FIGS. 11A and 11B are illustrations of estimated best beam directions with a number of measurement combinations set to 30 according to some embodiments;

FIG. 12 is a block diagram illustrating an autoencoder architecture for learning power allocation dictionary for a specific environment according to some embodiments;

FIG. 13 is an illustration of estimated best beam directions with autoencoder learning with a number of measurement combinations set to 10 according to some embodiments;

FIGS. 14A and 14B are illustrations of estimated best beam directions with principal component analysis (PCA) decomposition with a number of measurement combinations set to 15 according to some embodiments;

FIG. 15 is an illustration of performing CS across a whole network;

FIG. 16 an illustration of overlapping sparse decoding areas in a large covered area according to some embodiments;

FIG. 17 is an illustration of dictionaries applied over beams in an overlapping fashion resulting in significant resource gains according to some embodiments;

FIG. 18 is a flow chart illustrating a beam selection procedure where the UE performs sparse decoding according to some embodiments;

FIG. 19 is an illustration of an example of a Broadcast Signal Burst in an OFDM system;

FIGS. 20A-20B are a flow chart of operations of a UE according to some embodiments;

FIGS. 21A-27 are flowcharts of operations of a network node according to some embodiments;

FIG. 28 is a block diagram of a communication system in accordance with some embodiments;

FIG. 29 is a block diagram of a user equipment in accordance with some embodiments

FIG. 30 is a block diagram of a network node in accordance with some embodiments;

FIG. 31 is a block diagram of a host computer communicating with a user equipment in accordance with some embodiments;

FIG. 32 is a block diagram of a virtualization environment in accordance with some embodiments; and

FIG. 33 is a block diagram of a host computer communicating via a base station with a user equipment over a partially wireless connection in accordance with some embodiments in accordance with some embodiments.

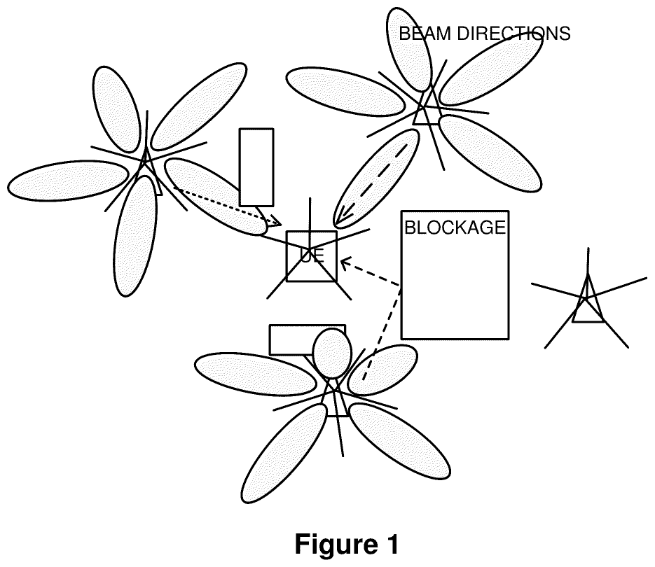

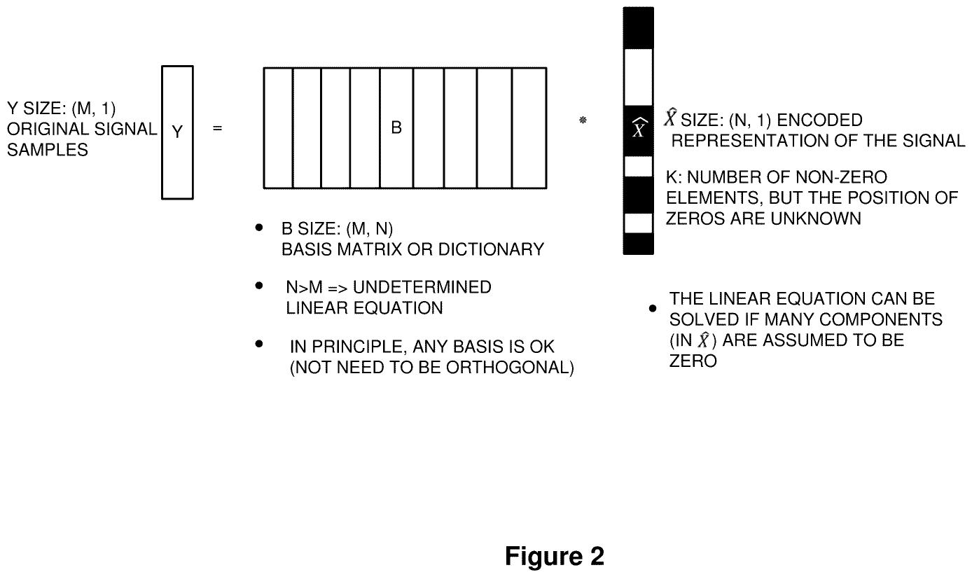

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The inventors have observed using CS for beam sweeping such that the best beam directions from all possible APs can be determined from a few transmissions without requiring a full scan search. The APs can transmit the same reference signal (RS) in all directions using the same time frequency resource and varying the transmit power allocations in a few combinations. The UE needs to measure only the composite received signal from all directions, it does not have to identify beams individually. The best beam direction(s) and corresponding channel gains can be determined using CS computation done either at the UE or at the network. The required transmission combinations may be optimized to the particular environment by using machine learning. Thereby the required number of measurements can be significantly smaller as compared to applying the conventional CS algorithms.

An overview of the CS observed by the inventors shall now be described.

Application of CS theory basis for beam scanning.

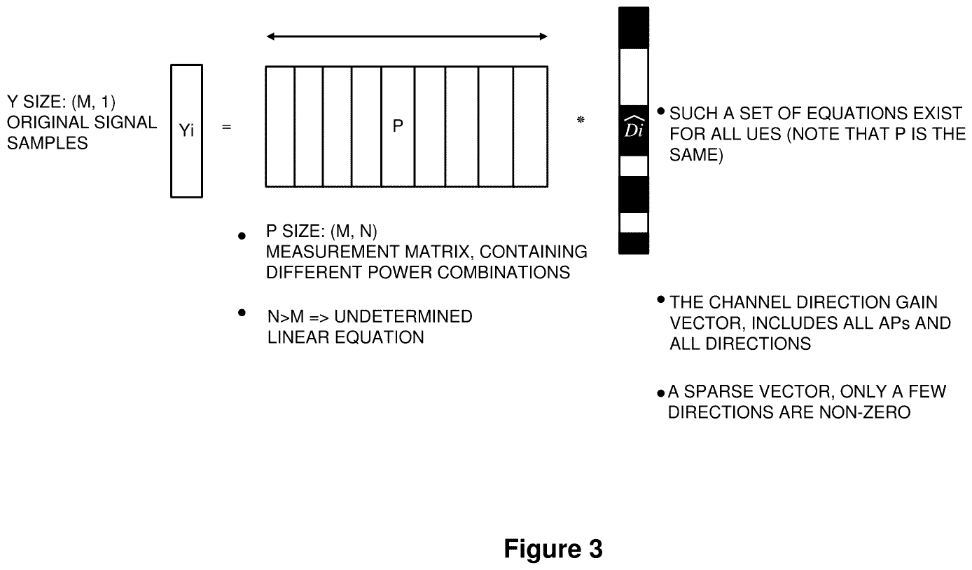

Applying the CS theory on the beam scanning problem in the various embodiments is illustrated in FIG. 3. The underlying observation and assumption is that the signal propagation is sparse in the spatial domain (in high mmwave, high frequency bands). This means that the vector that includes the channel gains from all APs and all directions would be sparse (i.e., it will have non-zero elements only in a few dimensions). In FIG. 3, the vector with the channel gains is denoted as vector \hat{D}, which has dimensions of N=L*B, where L is the number of APs and B is the number of beam directions per AP. Such a \hat{D}_{ι} vector exists for all UEs, hence the indexing i.

The measurement matrix P is a power allocation matrix in this case, which means that each row of the matrix describes a power allocation vector, which specifies how much power is allocated to each beam for the transmission of the reference signal in the system. Each row specifies a different power allocation, which can be executed one-by-one as a transmission. The matrix multiplication of P and \hat{D} is executed by the transmission of the beam scan reference signal from all APs in all directions with a power allocation specified by the given row of P. Note that all beams would transmit the same signal form and the multiplication operation would essentially happen over the air via the physical mixing of the signals. The combined received signal at the UE will be the corresponding element in vector Yi. There will be as many transmissions as the number of rows (i.e., the number of different power allocation combinations).

In order for the summation of the signals over the radio interface to happen, it is necessary to transmit synchronously on the different beams. The time synchronization does not have to be phase coherent as a symbol level synchronization would be sufficient. In case of a D-MIMO system such as a time synchronization is feasible to assume and would be needed for the coordinated transmissions anyway.

Then the vector \hat{D}_{ι} can be inferred from the observed measurements Yi. This calculation can be performed by using one of the reconstruction CS algorithms, such as Orthogonal Matching Pursue (OMP) or Iterative Hard Thresholding (IHT), Basis Pursuit (BP), etc. The goal is to reconstruct the sparse signal from as few measurement combinations as possible (i.e., as few rows in matrix P as possible).

The power allocation matrix P is determined by the network and would be the same for all UEs. In other embodiments, the matrix P can be obtained by a learning process where the most “optimal” power allocation vector is determined by fitting to the actual measurement data. In CS theory there are algorithms that can be used for such learning, also called dictionary learning in CS.

For dictionary learning of matrix P, learning measurement samples are collected where the sparse \hat{D} vectors are directly measured, which means to execute the classical beam scanning procedure. Based on the collected samples, the learning algorithm finds the optimal power allocation matrix such that the \hat{D} vectors can be reconstructed from as few measurements as possible (i.e., from the shortest possible measurement vector Y). Via the learning the algorithm would try to find the most “optimal” P matrix, which allows the easiest reconstruction for the most typical beam combinations.

### System Realization of CS Based Beam Scanning

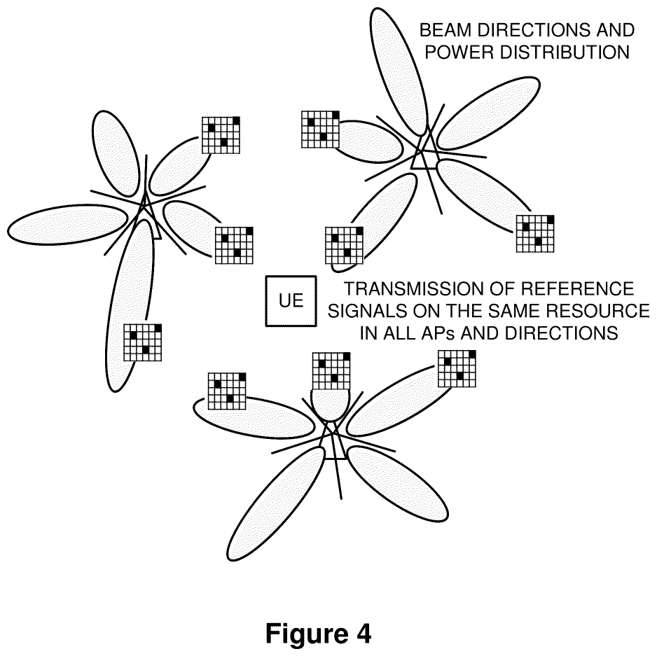

The transmission of beam reference signals in the various embodiments is illustrated in FIG. 4. Each AP transmits the same reference signal on the same time-frequency resource in all directions (as illustrated with the same pattern resource grids in FIG. 4). What differs between the different beam transmissions is the allocated power per beam (indicated with the different size beams in the figure).

The different power allocation combinations are according to the power matrix P in the CS equation. The different power allocations (i.e., the different rows of matrix P) are rotated continuously (going row-by-row of the matrix P) and the reference symbols are transmitted according to these power allocations periodically.

The UEs measure the received combined signals by measuring the power level of the signal for each power allocation combination one-by-one. It is possible to do some time averaging between multiple transmissions of the same power combination in order to reduce the effect of fast fading, for instance.

The transmission periodicity of the different power combinations is determined a-priori and can be signaled to UEs on the system information.

There can be two main variants of the solution depending on where the CS computation is performed at the UE or at the network side.

### UE Side CS Computation

In this case, the power allocation matrix P needs to be signaled to the UE and the UE calculates the sparse vector \hat{D} to determine the feasible beam directions and it signals back to the network the best beam directions. (It only needs to signal back the vector indexes, i.e., beam indexes that are above a certain threshold instead of the complete \hat{D} vector.)

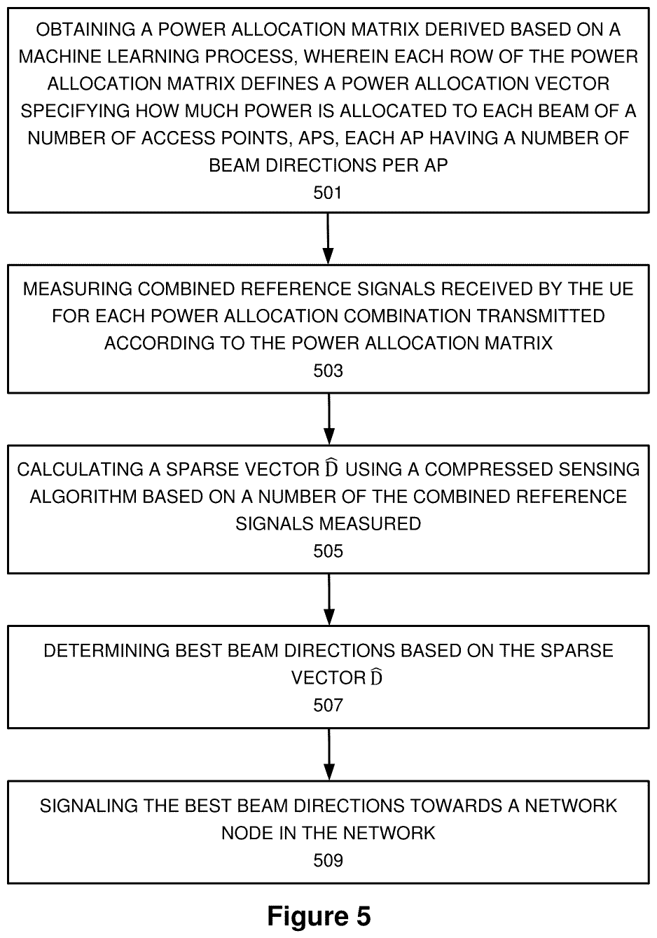

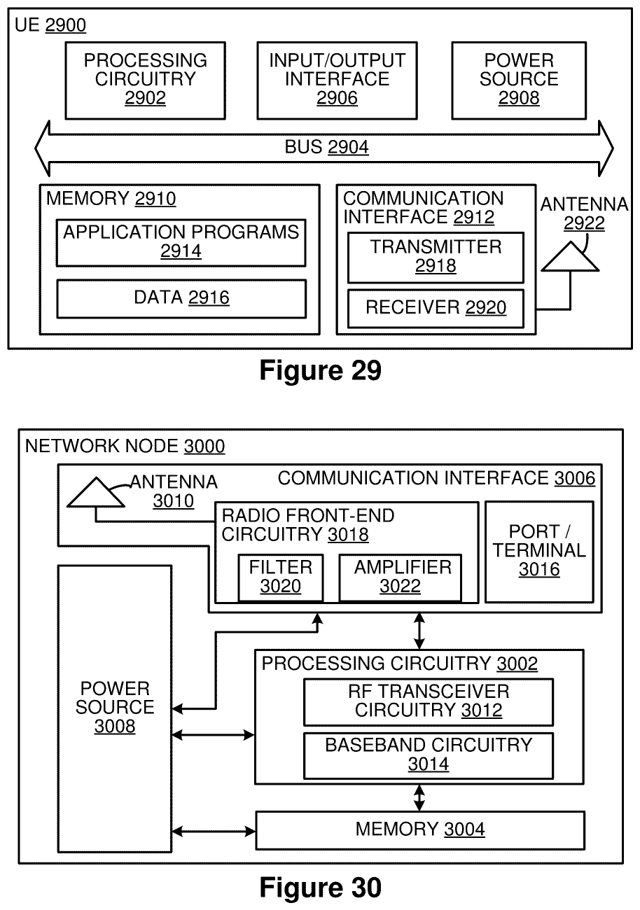

FIG. 5 illustrates operations the UE performs in UE side CS computation. The UE 2900 (implemented using the structure of the block diagram of FIG. 29) will be used in describing the flow chart of FIG. 5. For example, modules may be stored in memory 2910 of FIG. 29, and these modules may provide instructions so that when the instructions of a module are executed by respective UE processing circuitry 2902, processing circuitry 2902 directs the UE to perform respective operations of the flow chart.

Turning to FIG. 5, in block 501, the UE 2900 obtains a power allocation matrix derived based on a machine learning process, wherein each row of the power allocation matrix defines a power allocation vector specifying how much power is allocated to each beam of a number of access points, APs, each AP having a number of beam directions per AP.

In block 503, the UE 2900 measures combined reference signals received by the UE for each power allocation combination transmitted according to the power allocation matrix. In some embodiments, the UE 2900 measures the combined references signals by measuring a received composite signal strength for each power allocation combination. The UE 2900 may transmit the measurement results to a network node in some embodiments.

In block 505, the UE 2900 calculates a sparse vector \hat{D} using a CS algorithm based on a number of the combined reference signals measured. The calculation has been described above and experimental results are provided hereinbelow. In some embodiments, the UE 2900 calculates the sparse vector \hat{D} based on a machine learning process. For example, the UE 2900 may calculate the sparse vector \hat{D} using one of an orthogonal matching pursue, OMP, an iterative hard thresholding, IHT, and a basis pursuit, BP. In some of these embodiments, the UE 2900 calculates the sparse vector \hat{D} based on dictionary learning.

In block 507, the UE 2900 determines best beam directions based on the sparse vector D. In some embodiments, the UE 2900 determines the best beam directions by determining which beam directions are above a threshold and indicating that the beam directions that are above the threshold are the best beam directions.

In block 509, the UE 2900 signals the best beam directions towards a network node in the network.

The network knows the mapping between the vector index and the actual physical beams, so it can map the index to the physical beams which should be used to transmit toward that UE.

### Network Side CS Computation

In these embodiments, the power allocation matrix P does not need to be signaled to the UE, the UE only needs to know the index of the power allocation combination that is currently being used for the reference signal transmission and measure on the composite received signal (similarly as it was in the previous case). The repetition pattern and periodicity of the different power allocation combinations can be distributed to the UE once, either via dedicated signaling or via system information broadcast.

The UE measures the received composite signal strength (optionally performing some time averaging) and reports the result back to the network (i.e., it reports the measurement vector Yi). The network performs the CS algorithms to reconstruct the sparse matrix \hat{D} and identifies the best beams to be used to transmit to the given UE. This same calculation is performed for each UE individually.

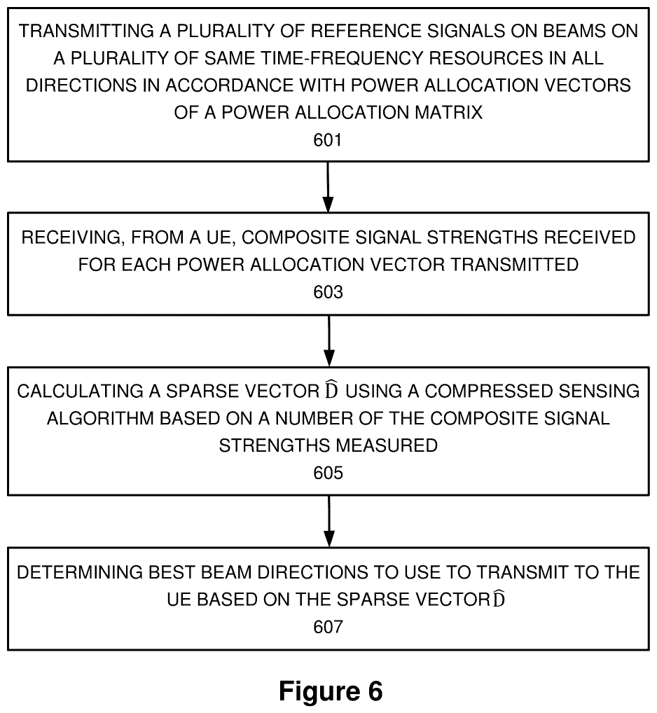

FIG. 6 illustrates operations the network node performs in network side CS computation. The network node 3000 (implemented using the structure of the block diagram of FIG. 30) will be used in describing the flow chart of FIG. 6. For example, modules may be stored in memory 3004 of FIG. 30, and these modules may provide instructions so that when the instructions of a module are executed by respective network node processing circuitry 3002, processing circuitry 3002 directs the network node to perform respective operations of the flow chart.

Turning to FIG. 6, in block 601, the network node 3000 transmits a plurality of reference signals on beams on a plurality of same time-frequency resources in all directions in accordance with power allocation vectors of a power allocation matrix.

In block 603, the network node 3000 receives, from a UE, composite signal strengths received for each power allocation vector transmitted.

In block 605, the network node 3000 calculates a sparse vector \hat{D} using a CS algorithm based on a number of the composite signal strengths measured. In some embodiments, the network node 3000 calculates the sparse vector \hat{D} based on a machine learning process. For example, the network node 3000 calculates the sparse vector \hat{D} using one of an orthogonal matching pursue, OMP, an iterative hard thresholding, IHT, and a basis pursuit, BP. In other embodiments, the network node 3000 calculates the sparse vector \hat{D} using the CS algorithm based on a number of the combined reference signals measured comprises iteratively calculating the sparse vector \hat{D} using the CS algorithm based on different numbers of the combined reference signals measured.

In block 607, the network node 3000 determines best beams to use to transmit to the UE based on the sparse vector \hat{D}. In some embodiments, the network node 3000 determines the best beam directions by determining which beam directions are above a threshold and indicating that the beam directions that are above the threshold are the best beam directions.

In some embodiments, the network node 3000 determines the power allocation matrix based on a machine learning process, wherein each row of the power allocation matrix defines a power allocation vector specifying how much power is allocated to each beam of a number of access points, APs, each AP having a number of beam directions per AP. In some of these embodiments, the network node 3000 determines the power allocation matrix based on dictionary learning.

In some embodiments of determining the power allocation based on dictionary learning, the network node 3000 collects learning measurement samples where the sparse vectors \hat{D} are directly measured and determines an optimal power allocation matrix such that the sparse vectors \hat{D} can be reconstructed from a shortest possible measurement vector.

In yet other embodiments, the network node 3000 determines the power allocation matrix based on dictionary learning by determining the power allocation matrix using an autoencoder neural network.

### Uplink Rx Side CS Scanning

The embodiments described above assumes that the CS based signal combination is applied on the downlink Tx powers. In an alternative embodiment, it is possible to employ the CS signal combination in the uplink Rx beamforming such that the base station (BS) multiplies the multi-antenna received signals with different decoding vectors, which would create different reception beam patterns (corresponding to the rows of the CS matrix). The UE transmits in the uplink a sounding reference signal, which is coherently received at the BS(s) and are multiplied with the different decoding CS vectors. The UE needs to transmit as many sounding signal occasions as the number of CS reception combination.

In such an uplink application of the CS scheme, the measurement signals need to be sent and processed per UE (as opposed to the common reference signal in the downlink case), which may imply a larger reference signal overhead. However, it could be applied at initial access when the UE may send the request signal in a few times and the BS would try to receive the signal in a few beam decoding combinations. During the reception the BS could receive the random access request and at the same time figure out the best beam direction (using the CS based scheme) and respond to the UE in the determined best beam direction.

Later, during data communication the per-UE uplink sounding reference signals would be sent periodically in-band and the BS may rotate the different beam decoding vectors (corresponding to the CS vectors) for the reception of these reference signals and based on that continuously determine the best beam direction.

### Experimental Results on Real Measurements

Initial testing using the embodiments described above using real measurements from a test network running on 39 GHz with 172 possible beam directions was done.

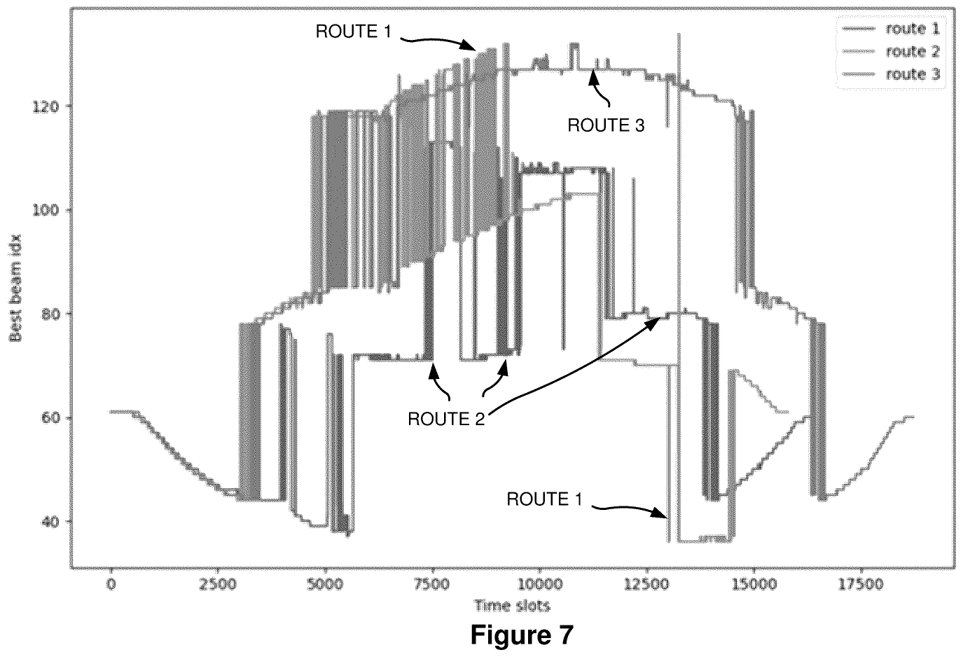

FIG. 7 is a plot of the best beam index as a function of time as the UE moves around (the three lines correspond to three different routes).

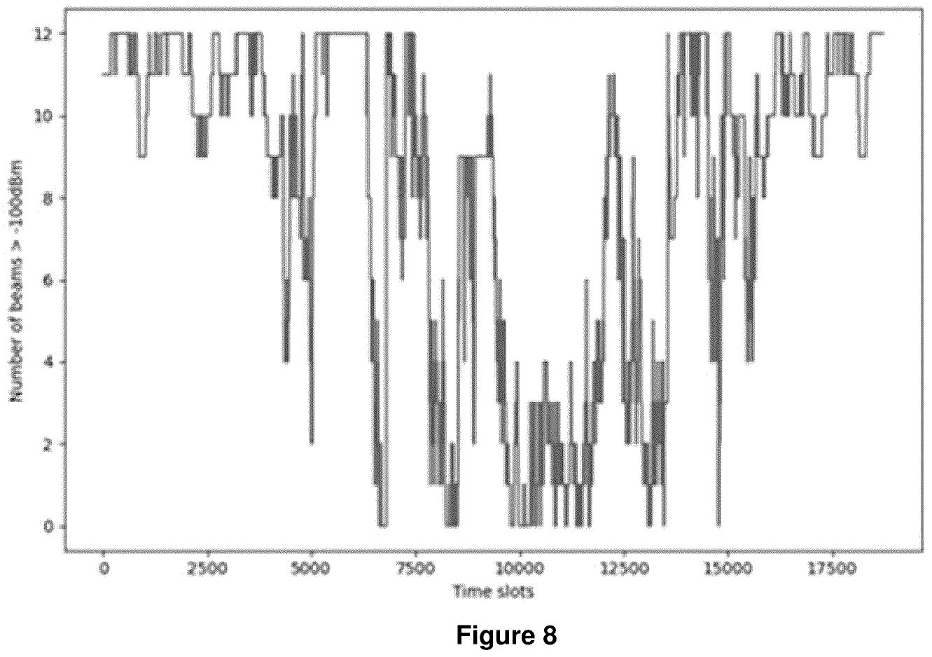

FIG. 8 is a plot of the number of beams that have measured signal strength above minus 100 dBm. These are the beams that may provide measurable coverage to the UE. Note that in most of the time the number of beams with good enough signal strength is less than 10, which in comparison to the total number of 172 beams is small, indicating the sparsity of the possible beam directions.

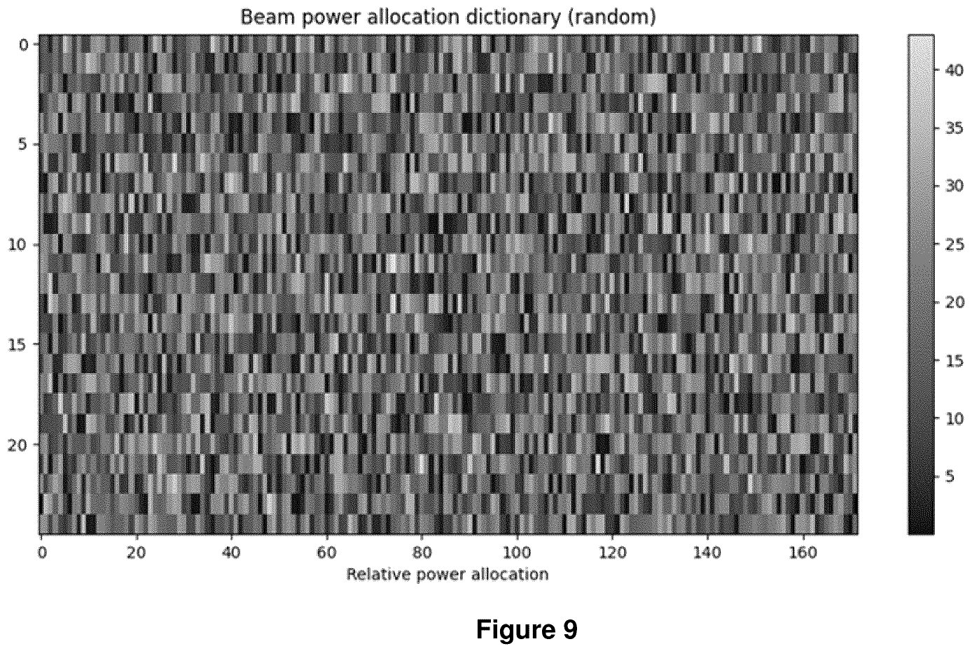

A measurement matrix P (i.e., the power allocation matrix) can be created as a randomly generated matrix in the simplest case and one can perform CS based reconstruction of the sparse beam direction vector (D) from a few set of measurements. Each row of the dictionary matrix corresponds to one measurement combination (i.e., one power allocation combination). An example measurement matrix (i.e., power allocation dictionary) is shown in FIG. 9.

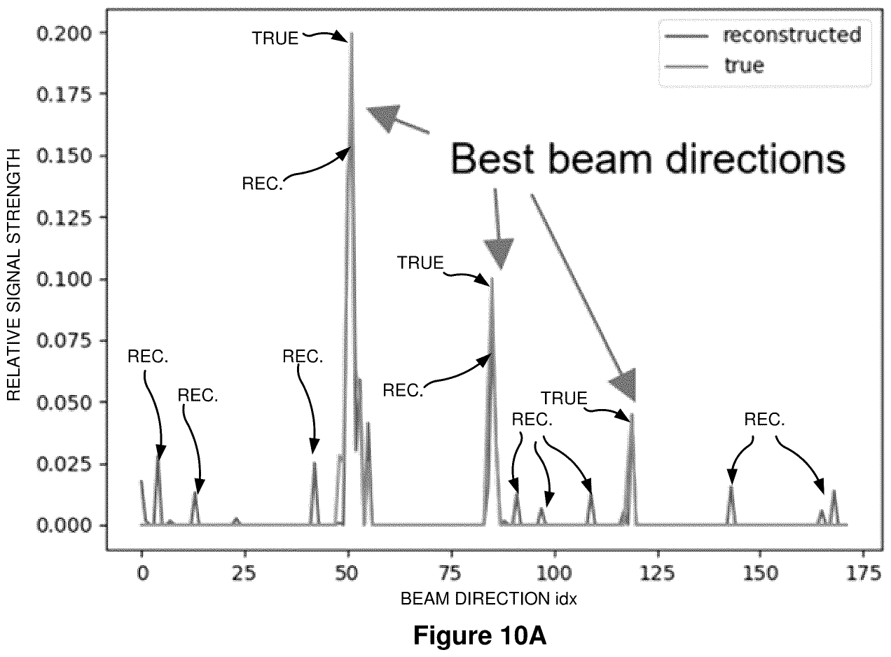

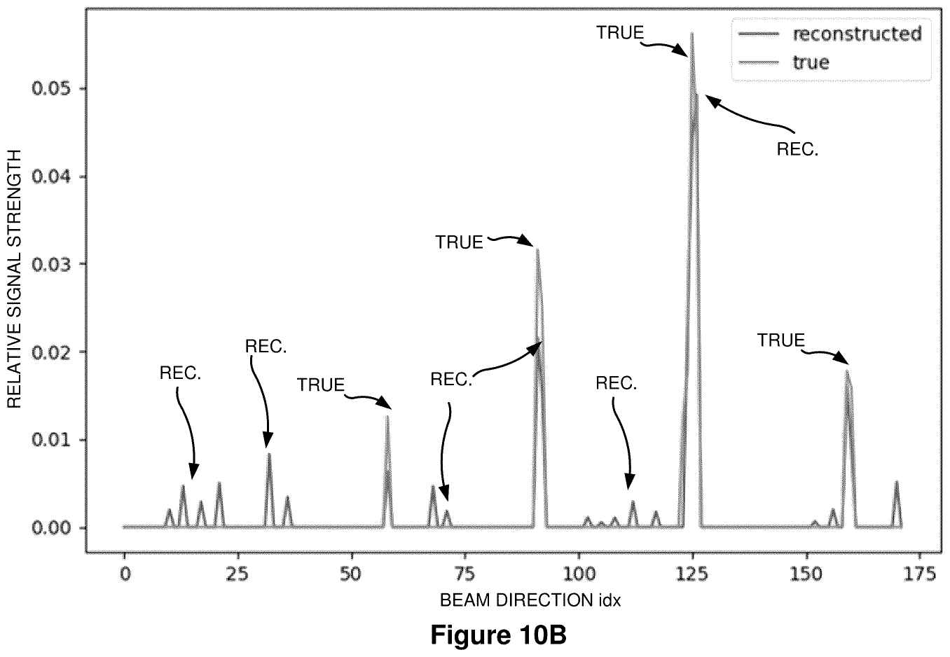

In FIGS. 10A and 10B, the estimated beam directions (more specifically, the relative signal strength of the beams in linear scale) for the true measured values and for the reconstructed values (REC) (i.e., reconstructed from the few measurement combinations with the help of the CS algorithm) are shown. One can see that the true and estimated best beam directions nicely coincide, though there are some weaker “noisy” estimations in other directions as well, which practically have zero signal strength in the real measurements.

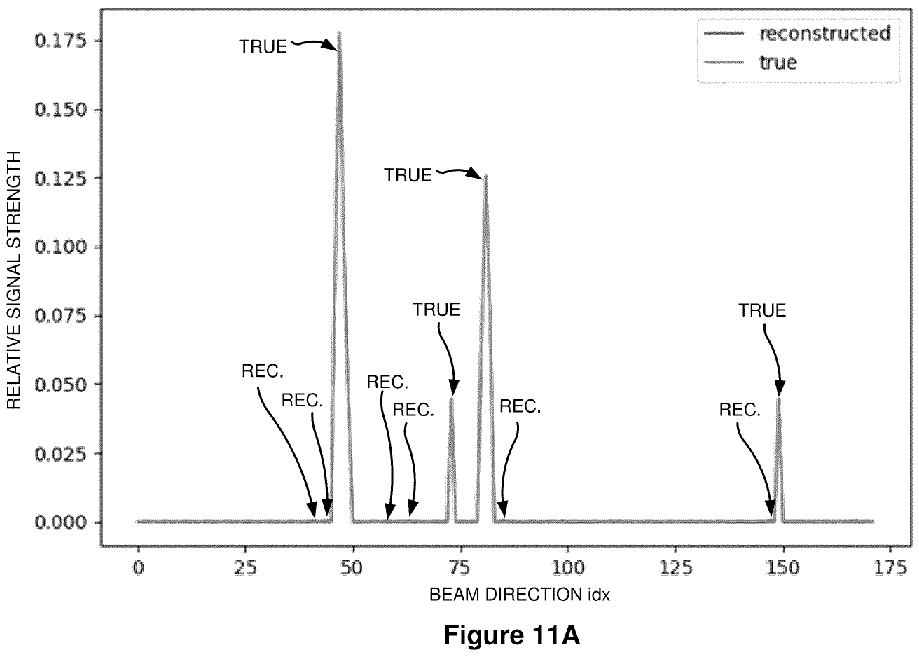

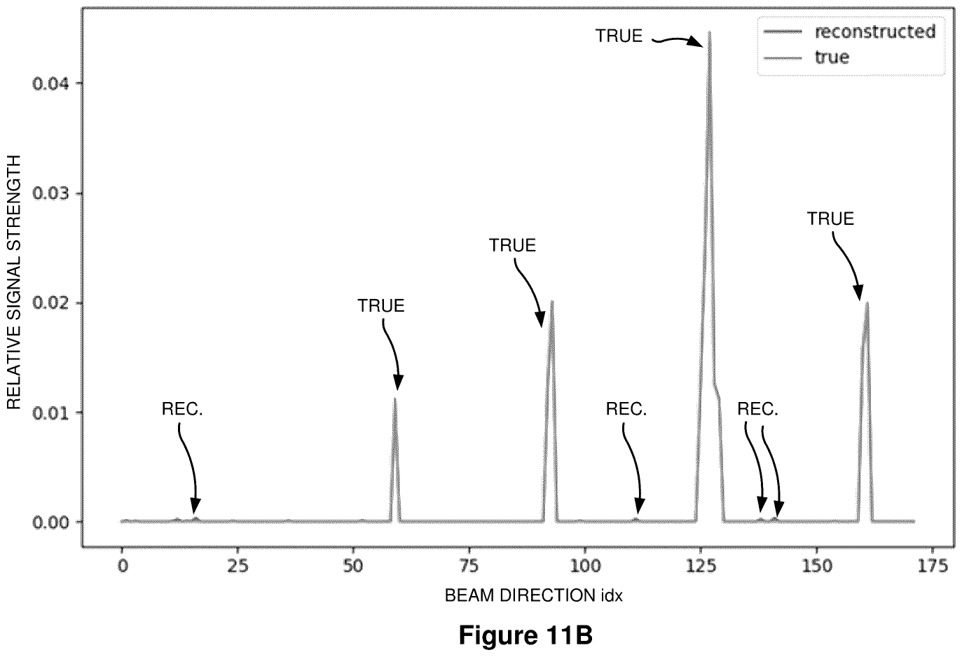

However, if the number of measurement combinations is slightly increased to 30, basically “perfect” beam direction estimations can be achieved, as shown in FIGS. 11A and 11B.

### Learning (e.g., Training) the Dictionary—Optimizing the Measurements

The power allocation dictionary can be optimized to the particular radio environment, that is, to the typical beam constellation patterns prevailing in the given environment. The number of required measurements and transmission combinations can be significantly reduced if the dictionary is optimized. In the following describe possible dictionary learning solutions to optimize the power allocation matrix.

Note that the conventional dictionary learning algorithms available in CS are not applicable for this problem, as those algorithms are optimizing the dictionary and the sparse code at the same time, while in the beam direction case, the sparse coding should not be subject to optimization as that is “given” by the physical radio propagation environment.

To optimize the power allocation dictionary, it is assumed that a representative set of beam constellation patterns (sparse codes) are available for the algorithms. In practice, this dataset can be collected by active dedicated measurements (drive tests, automated AGVs, drones, etc.) or by building the database online, enabling continual learning. The latter option is feasible because the use case is valid and working with random power allocation dictionaries, while the optimized dictionaries make it more efficient with building up the database.

### Learning (e.g., Training) the Dictionary by Deep Neural Network

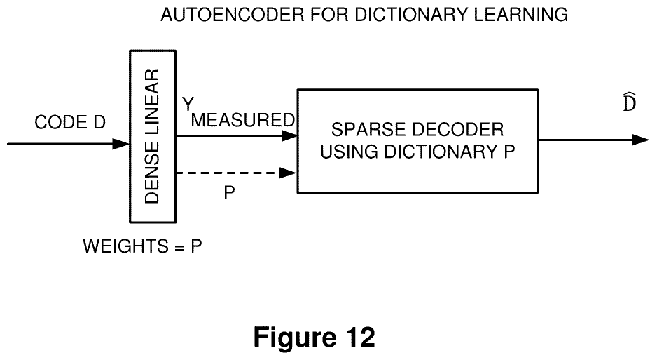

In this embodiment the power allocation dictionary learning is performed with an autoencoder Neural Network (NN). The dictionary is represented by the weights of a neural network layer in the encoder with linear activations and zero biases. The decoder NN module is used to perform the sparse coding on Y and the P dictionary, which is given explicitly to the decoder or learnt implicitly through a large training dataset (see FIG. 12). The training of the autoencoder is the measured sparse code dataset (beam pattern).

Note that the decoder function and the loss function must be differentiable to be able to teach the NN with backpropagation. This can be achieved by a differentiable implementation of a sparse coding algorithm or this algorithm can be learnt by a NN module, which acts as a function approximator in this case, and it can be trained as part of the autoencoder or in advance.

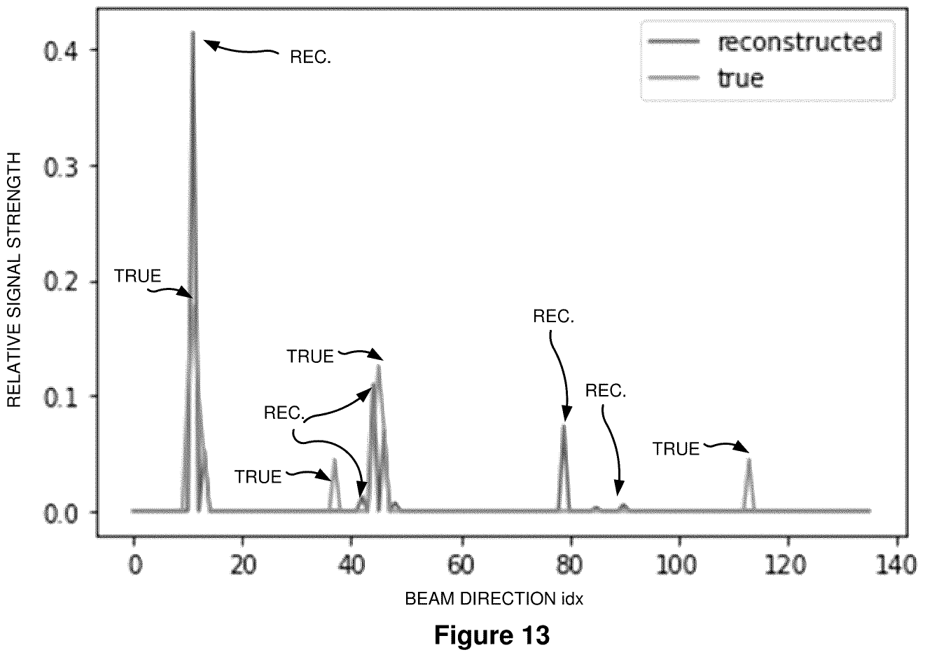

A further option for autoencoder implementation is to use the pseudo-inverse of dictionary weights P in the decoder module. In this case, Y is multiplied by pseudo-inv(P) to approximate the original input sparse code D. FIG. 13 shows the resulting beam pattern estimation for 10 measurements.

### Dictionary Dimensionality Reduction

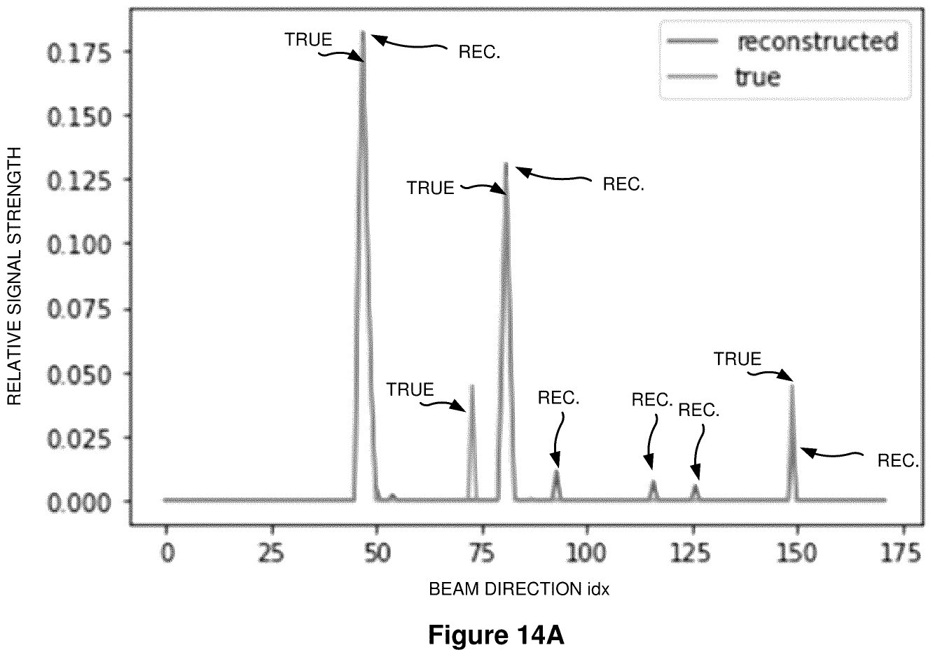

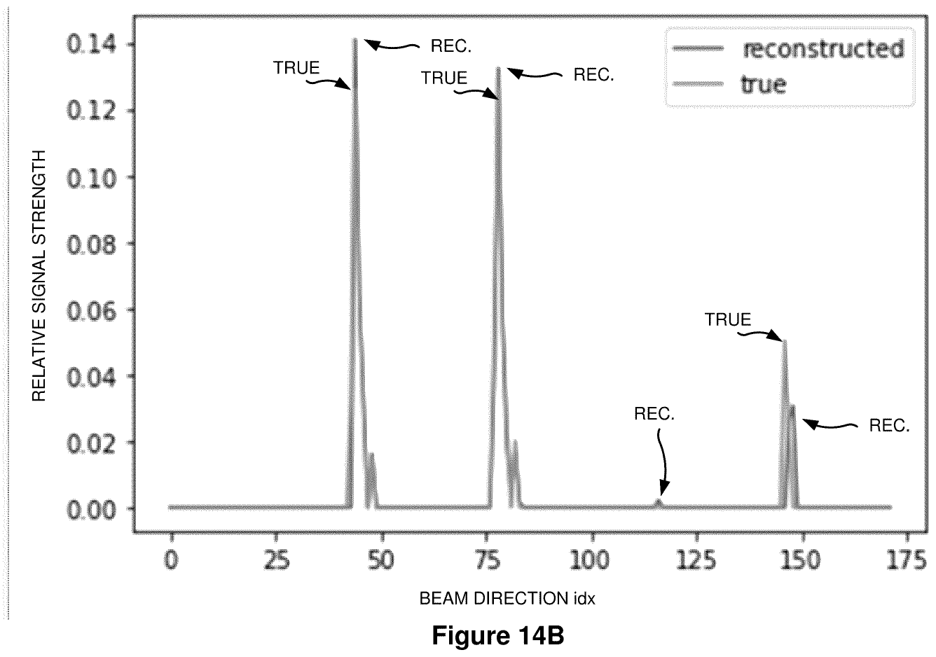

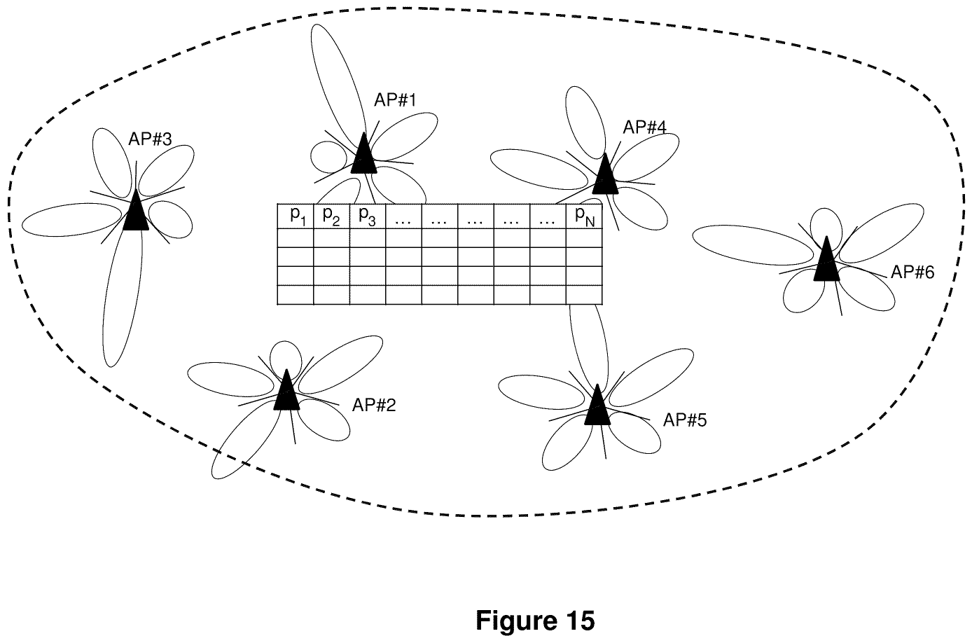

In some embodiments, the set of sparse codes are projected into lower dimensional sub-space with dimensionality reduction techniques, like linear Principal Component Analysis (PCA), or any other suitable algorithm. The number dimensions of the sub-space N_{features} can be defined in advance, which, eventually will determine the number of beam measurements for best beam selection. The subspace-search will provide a matrix P′ which is efficient in reducing the dimensions of the sparse codes and the Y values representing the aggregated measurements. By this, an efficient the power allocation matrix P can be derived as P=pseudo-inverse(P′). A sample result of this implementation is shown in FIGS. 14A and 14B. Thus, the network node 3000 projects a set of sparse vector codes into a lower dimensional sub-space via one or more dimensionality reduction techniques and determines a power allocation sub-matrix in the lower dimensional space. The network node 3000 derives the power allocation matrix by determining a pseudo-inverse of the power allocation sub-matrix.

The proposed methods can be generally applied to any beamforming system, being it single AP or multiple AP system. When applied in a multi-AP scenario, e.g., in a D-MIMO setting, the benefits can be more significant than in a single point MIMO scenario as the number of possible beams or beam combinations are much higher in a D-MIMO setting. Moreover, the dictionary learning algorithm and the application of CS needs to be adapted to the D-MIMO case in a few details, as outlined below.

### D-MIMO Aspects

In the power allocation dictionary, the power of the beams corresponding to the same AP need to be normalized to the AP total transmission (Tx) power, while power to beams corresponding to different APs have independent sum of power constraints. This needs to be taken into account as constraints in the dictionary learning process, in particular in the cost function of the ML optimizer. Thus, the network node 3000 normalizes a power of beams corresponding to a same AP to AP total transmit power.

To conclude, while CS based beam selection shows efficiency gains, especially with a trained dictionary, existing or published technologies such as the methodology described above and illustrated as an overview in FIG. 3 are not scalable in large and highly overlapping AP coverage areas.

In various embodiments described hereinbelow, the whole covered area is decomposed into multiple smaller areas (i.e., a Sparse Decoding Area—SD area) in order to make the CS beam search scalable in large networks. These sparse decoding areas are typically partially overlapping and each of them has an assigned dedicated dictionary.

The dictionary used for calculating the sparse decoding will be dependent on the UEs locations (e.g., a UE with a given position will belong to one or more SD areas). The process of sparse decoding and the dictionary used can either be under network or UE control.

The various embodiments enable balancing the trade-off between using small dictionaries (i.e., small SD areas) with many dictionary-switching vs. using larger dictionaries (larger SD areas) with less dictionary switching. It is possible to select the appropriate SD area and dictionary size considering deployment scenario, i.e., density of APs, coverage area of beams, user mobility etc. In other words, it can be up to a network operator or a network owner to select the SD area and dictionary size best fitting the network of the network operator or the network owner.

As the sparse decoding areas can be overlapping, the assigned dictionaries may also be overlapping (on APs or beams), which allows the reference signal powers to be modulated with the same dictionary elements on overlapping beams. In this way, the reference signals of different sparse decoding areas can be transmitted on the same resources (same timeslots, frequencies, etc.).

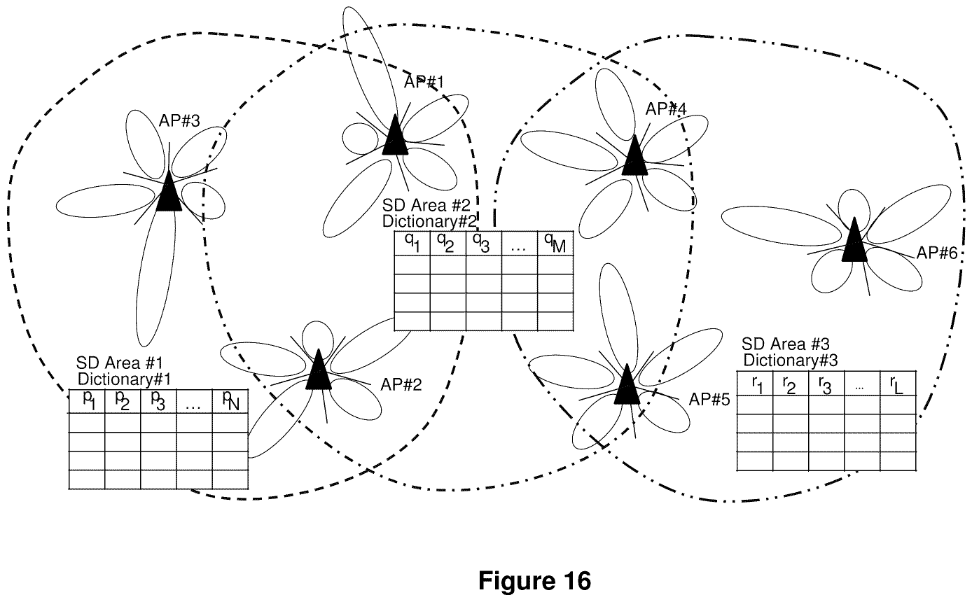

FIG. 16 depicts an area where any UE position has only a limited number of covering beams (APs), but there is a significant overlap among many of the beams. Due to high overlaps, the known CS based beam selection method described above in FIGS. 3-14 requires a single large dictionary applied for all AP beams and sparse decoding processes. This becomes computationally expensive in large coverage areas.

In order to make this decoding scalable, a number of partial coverage areas (Sparse Decoding Areas, SD Areas) are defined with a dictionary associated with each SD area. A UE located within a SD Area will receive the beam reference signals (RS) modulated by the corresponding Dictionary, and the received power measurements will be used to select the best beam by doing sparse decoding with the specific Dictionary. The size (the number of columns in the matrix) of this Dictionary need not be larger than the number of potentially detectable beams, which is limited, making the beam selection procedure scalable regardless of the total number of beams in the whole area.

The overlapping SD areas and dictionary matrices have at least two important system requirements to solve: continuously resolving the UE-SD area mapping and training the SD area dictionaries in a coherent way (due to column overlaps).

Thus, scalable beam selection solution for large areas is provided, where any UE position is covered only by a limited set of APs, with many overlapping APs and beams. Some embodiments are applicable for untrained (pseudo-) random dictionaries, and some for trained dictionaries with the described training methods. Smaller decoding complexity may be achieved due to smaller dictionaries applied. A decreased number of measurements may be required due to smaller dictionaries and scanning time can be significantly shortened. In some embodiments, parts of dictionaries may be reused between neighboring areas to reduce measurements, RS resources needed and scanning time. In some embodiments, a possibility is enabled to reuse radio resources allocated for transmitting CS beam combinations across the network.

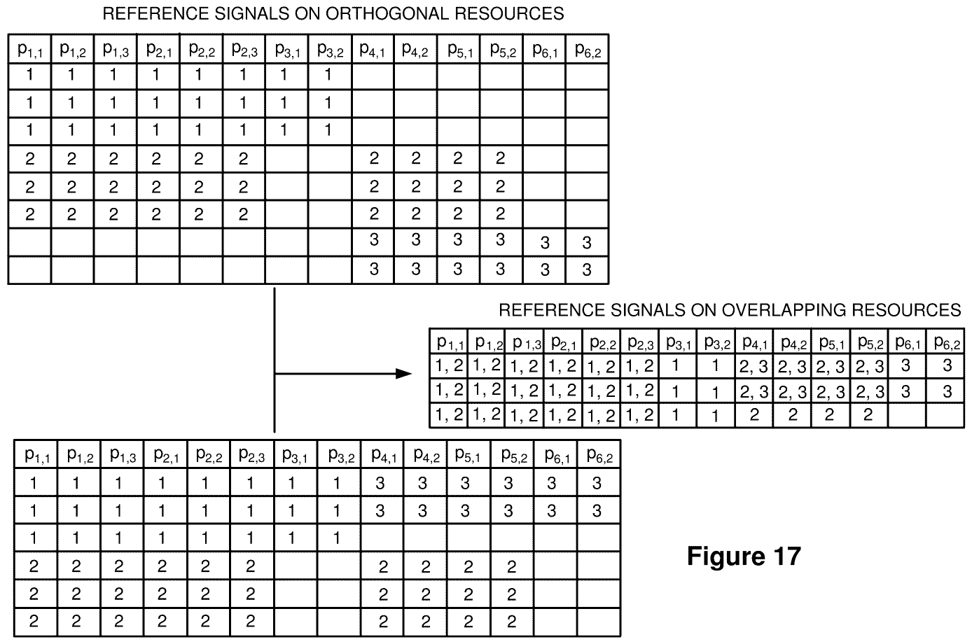

As the SD Areas are overlapping on individual beams, the corresponding Dictionaries will also be overlapping on their columns. This is illustrated in FIG. 17. They may, however, have different number of rows, so that small SD Areas allow lower complexity of sparse decoding. In FIG. 17, the table heading “p_{x,y}” indicates the power allocated to beam y in AP x. The AP to SD area mapping is the same as in FIG. 16 but with a reduced number of beams per AP (2 or 3 depending on AP number) to make the table more easily readable. Two different main embodiments are considered for the RS allocation scheme between SD areas, also shown in FIG. 17: on orthogonal resources and on overlapping resources.

For the case of orthogonal resources, for each AP and a given point in time (rows in the matrix), a single RS is transmitted associated only with a single SD area (indicated by a number in the table with the SD area the AP is associated with). Here, analog beamforming is assumed and hence specific beam weights are applied in a given time instance to all resources transmitted by the AP. This means that different RSs would have to be time multiplexed. That is, if an AP is covering multiple SD areas, the multiple RS transmissions would be time multiplexed, negatively impacting the time it takes to cycle through all power allocations and SD areas. In case SD areas are completely separated (1 and 3 in this example), the time can be reduced, see lower left option in FIG. 17. This type of scheme allows optimization of the dictionary for each SD area separately but results in longer scanning times and it will consume more radio resources compared to a scheme with overlapping RS resources.

### Dictionary Descriptor

Sparse decoding is performed by using the specific dictionaries, which are assigned SD Areas. These dictionaries can be pre-shared as data matrices over the air interface to the UE (in case the UE performs the sparse decoding), or it can also be a pseudo-random sequence generated by both the network and the UE by the same algorithm.

Using the pseudo-random dictionary does not require data/model sharing in advance, it results in less efficient decoding than using a learned dictionary.

The mapping between the SD Areas and the corresponding dictionaries are defined a dictionary descriptor, which can take multiple forms, e.g.,
the dictionary matrix itself,
identifier of a dictionary matrix, where the matrices and the mapping are known by both the UE and the network, e.g., pre-stored in the UE/SIM, a set of matrices downloaded to the UE prior to performing sparse decoding. The identifier could for example be the SD area index.
descriptor (e.g., bitmask) to form a dictionary with a subset of columns from a larger dictionary
an initial state to a pre-defined pseudo-random matrix generation in the specification. In this case the UE also needs to know the number of measurements to perform (the rows of the matrix. This can be communicated through the “RS resource handling”, see that section) and how many beams (beams across the APs in the SD area) to include (i.e., the columns of the matrix). Such information could be provided together with the initial state.

Such dictionary descriptor could be sent in a broadcast manner using e.g., system information, or by dedicated RRC signaling, MAC control elements or L1 control signaling.

### Dictionary Training

Although dictionaries with random elements can also be efficiently used for beam selection, a dictionary trained for the local environment can be significantly more efficient. Due potentially high level of overlapping, training of individual dictionaries are not independent of each other.

The baseline procedure for dictionary training, i.e., when training one single dictionary is described above. The extensions described below are added to the baseline procedure in order to handle the training of overlapping dictionaries.

In one embodiment, the dictionaries are trained sequentially one after the other. The first dictionary is trained without constraints. The dictionaries trained after the first dictionary is trained will have fixed columns, determined by the overlapping already trained dictionaries, which results in constrained optimizations (assuming overlapping RS resources for the dictionaries, also accounting for potential limits of total power per AP). This iteration is repeated until all dictionaries are trained. This solution is simple, fast, and scales well with the number of beams in the whole coverage area.

In another embodiment, the dictionaries are trained in an iterative fashion. The first dictionary is trained without constraints. The dictionaries trained after the first dictionary has been trained will have columns with initial values determined by the overlapping already trained dictionaries. However, in this case, the overlapping columns are not fixed but it has a regularization term which tries to keep these columns close to their initial values. This iteration is repeated until all dictionaries are trained, and then started again in an outer loop until convergence. This solution still scales well and results in a more optimal solution at the cost of increased computation.

In yet another embodiment, the dictionaries are trained simultaneously. In the forward path, the transmission happens according to one big dictionary, and the sparse decoding is performed on the relevant columns only. At this point, the loss values are calculated, and the backward path is calculated using the obtained gradients. Due to the overlaps in dictionaries (i.e., overlapping columns in the individual dictionaries) the overlapping gradients will be averaged and converge to a joint optimum.

### Beam Selection Procedure

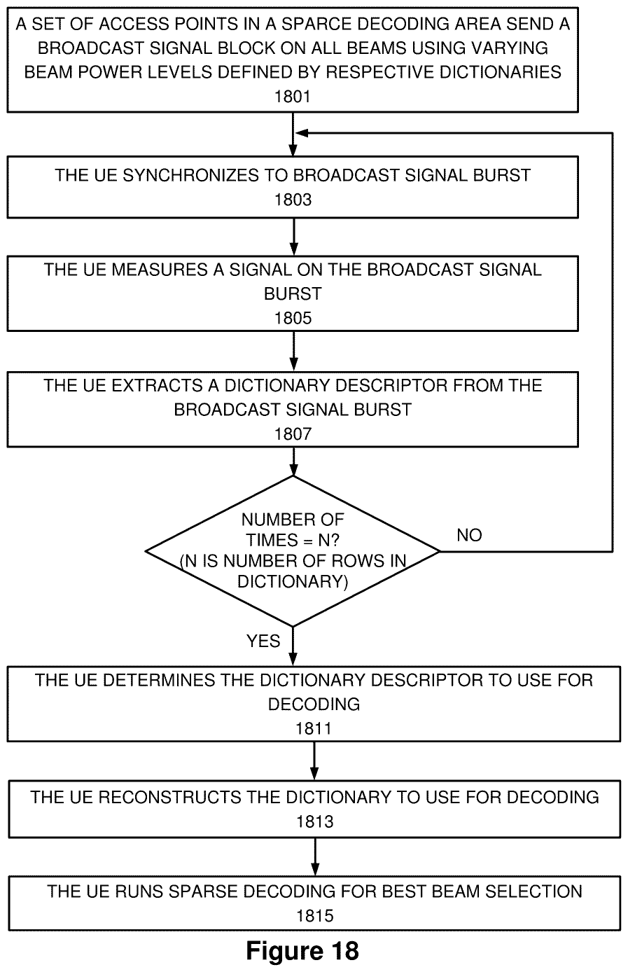

A beam selection procedure is illustrated in FIG. 18. The process of sparse decoding can be done either in the UE or in the network.

The embodiment described below and illustrated in FIG. 18 assumes UE side decoding, but it is also applicable for network side processing. It further assumes that the RS resources and the dictionary descriptor are sent using broadcast signals (see Section on “RS resource handling” and “Dictionary descriptor”).

The anticipated difference is that in case of network side decoding the UE should send the signal strength measurements and potentially the Dictionary Descriptor to the network for processing.

FIG. 18 shows the steps of the beam selection procedure. The whole covered area consists of overlapping SD Areas. The APs send a Broadcast Signal burst on all beams, which, in a specific embodiment, contains a synchronization signal and Dictionary Descriptors. The transmission power level of beams belonging to the same SD Area are determined by the respective Dictionary values. Note that there may be multiple Dictionary Descriptors in a Broadcast Signal Burst sent on a specific beam. Practical realization details will be discussed below.

In the next steps, the UE synchronizes to the first Broadcast Signal, where the power of the beams for each transmitting AP is determined by the first row of the SD Area Dictionary. The UE measures a signal on the received broadcast signal. Such measurements could be based on Reference Signal Received Power (RSRP), which is the aggregated power for all detectable beams, Received Signal Strength Indicator (RSSI), which is the aggregated power for all beams as well as the experienced noise and interference, or, Signal-to-Interference-plus-Noise Ratio (SINR), which is the ratio between the aggregated power for all detectable beams to the experienced noise and interference. The measurements will serve as the measured input to the beam selection algorithm. The UE also extracts the Dictionary Descriptor from the Broadcast Signal. There can be multiple such descriptors broadcasted if the received beams belong to multiple SD Areas. In this case, all the descriptors are stored together with some weight indicator (e.g., received power level), which will be used later to select the best Dictionary Descriptor to use in the decoding algorithm. These steps are repeated n times, where n, in one embodiment can be equal to the maximum number of rows in all possible Dictionaries.

In the final steps, the UE determines the Dictionary Descriptor, which can be a selection of combination of the descriptors extracted in the individual measurement steps, depending on the descriptor type. Based on this descriptor, the UE reconstructs the Dictionary to use for sparse decoding.

Finally, the sparse decoding algorithm for beam selection is performed using the obtained received power measurements and Dictionary.

The beam selection procedure described above is one example realization, further embodiments are described herein.

### Broadcast Signal Burst

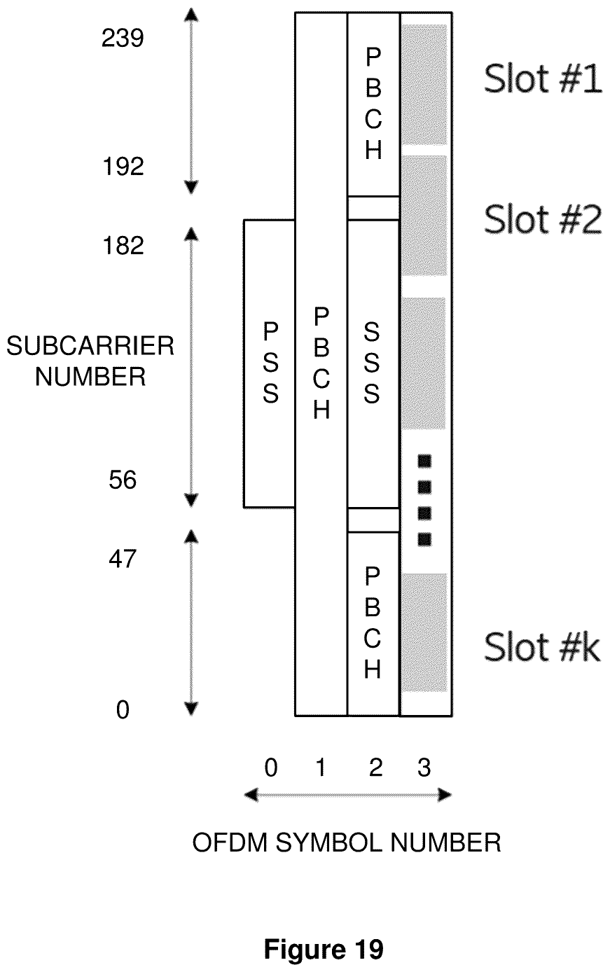

The Broadcast Signal Burst (also referred to as a signal burst) includes n Broadcast Signals. It may include a synchronization signal (like PSS and SSS in 5G NR), which may be required if the UE is performing initial access, but not necessary if the UE is already connected and is performing beam tracking. The Broadcast Signal also contains k resource slots for the Dictionary Descriptors. FIG. 19 illustrates an example of a Broadcast Signal Burst in an OFDM system such as 5G NR. Multiple slots allow APs to send potentially overlapping Dictionary Descriptors. If the descriptor is an identifier of a SD Area, then up to k overlapping SD Area IDs can be broadcasted on a single beam. The AP beam-slot assignment can be determined a-priori (e.g., at AP configuration time), and it can be updated at any time in a synchronized way. If the descriptor is a set of dictionary columns (bitmask of columns), then the logical OR of the individual dictionary bitmasks can be transmitted in the slots, one bit per slot.

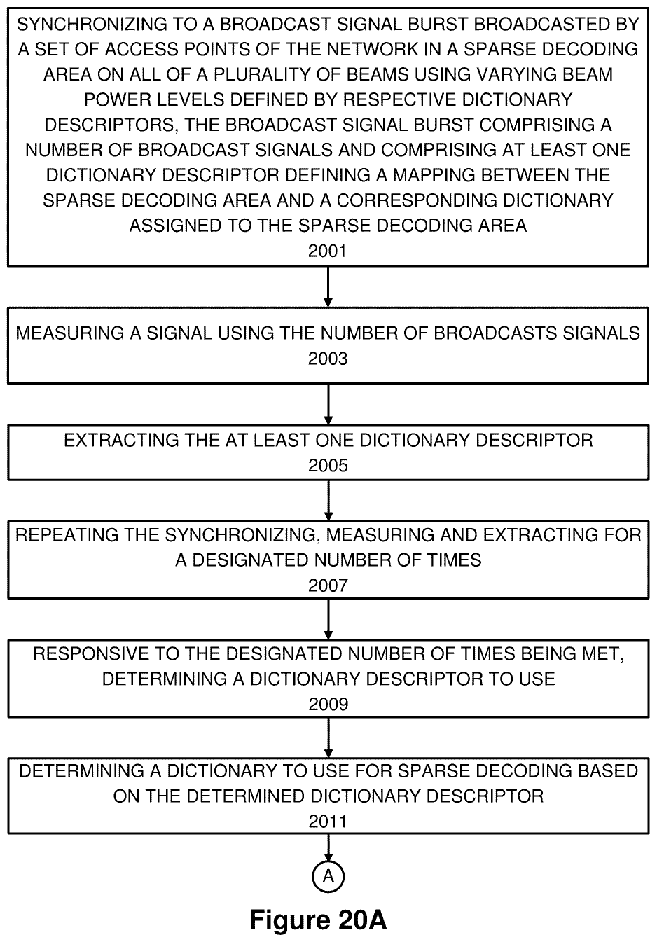

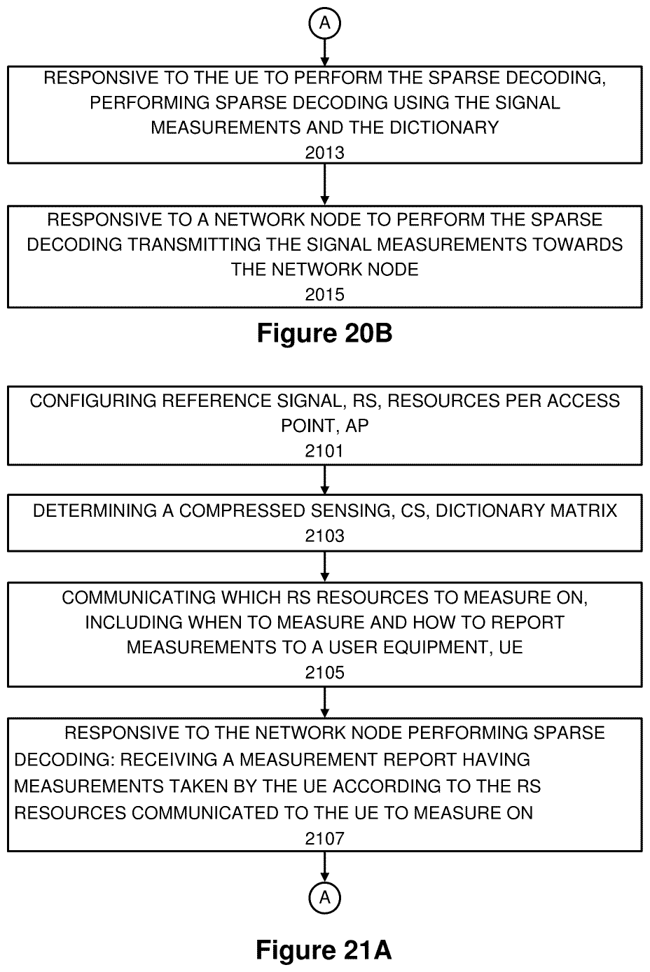

Thus, the UE 2900, as illustrated in block 2001 of FIG. 20A, synchronizes to a broadcast signal burst broadcasted by a set of access points of the network in a sparse decoding area on all of a plurality of beams using varying beam power levels defined by respective dictionary descriptors, the signal block burst comprising a number of broadcast signals and comprising at least one dictionary descriptor defining a mapping between the sparse decoding area and a corresponding dictionary assigned to the sparse decoding area. The broadcast signal burst has n Broadcast Signals and k resource slots for the at least one dictionary descriptor.

### Additional Embodiments of Beam Selection Procedure

Main procedural steps are shown below for different embodiments if the sparse decoding is performed:
i. In the UE 2900 or in a network node 3000
ii. For non-overlapping/orthogonal or overlapping resource mapping between SD areas

RS resources refer to the radio resources used by the UE 2900 for performing measurements used by the sparse decoding algorithm.

### Sparse Decoding Performed in Network Node With Orthogonal RS Resources Between SD Areas

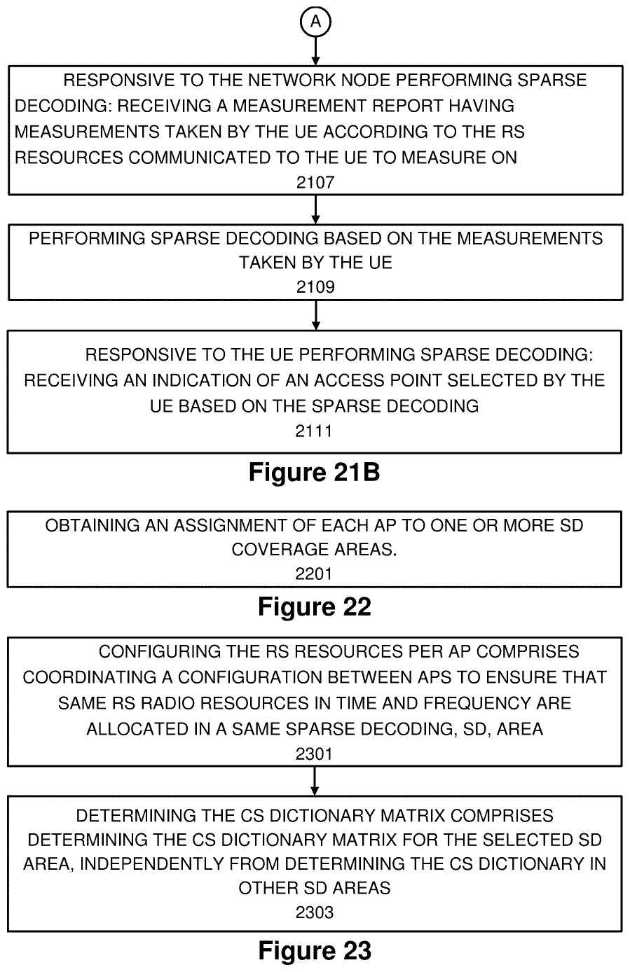

The steps consist of:
1) Assignment of each AP to one or more SD coverage areas [how this assignment is done is up to the network operator, the network owner, etc.]. Thus, as illustrated in block 2201 of FIG. 22, the network node 3000 obtains an assignment of each AP to one or more SD coverage areas.
2) Configuration of RS resources per AP, coordinating the configuration between APs. This is illustrated in block 2101 of FIG. 21A where the network node 3000 configures reference signal, RS, resources per access point, AP. This is done to ensure that
   a. Same RS radio resources in time and frequency (e.g. resource elements (REs) in NR) are allocated (across the multiple instances of RS transmissions between APs in the same SD area. This is illustrated in block 2301 of FIG. 23 where the network node 3000 configures the RS resources per AP by coordinating a configuration between APs to ensure that same RS radio resources in time and frequency are allocated in a same sparse decoding, SD, area. This also includes a certain level of time synchronization regarding radio resources on the air interface between AP in the same SD area to ensure that the received RSs at the UE are still to a large extent overlapping to perform sequence detection (e.g. within the CP of OFDM transmissions).
   b. The same RS sequence is used by APs belonging to the same SD area (the same or different RS sequence could be used by APs belonging to other SD areas).
   c. APs belonging to multiple SD areas configure non-overlapping (orthogonal) RS resources
3) As illustrated in block 2303 of FIG. 23, the network node 3000 determines the CS dictionary matrix for the selected SD area, independently from determining the CS dictionary in other SD areas. (The dictionary matrix can be determined in different ways, previously described above, including random dictionary, learnt dictionary, etc.)
4) Transmission of the RS resources according to the RS configuration and to the CS dictionary in each AP.
5) Ensuring information at the UE regarding which RS resources to measure on. Thus, as illustrated in block 2105 of FIG. 21A, the network node 3000 communicates which RS resources to measure on, including when to measure and how to report measurements to a UE 2900. Such information would include information on where RS resources are mapped and also which resources should be used for each UE measurement (and hence also providing an understanding of how many separate measurements the UE should perform). This information could be made available through
   a. Specification text and for example conditioned on detection of synchronization signals/broadcasted system information, see more information “Beam selection procedure” and “Broadcast Signal Burst” described above.
   b. Specification text and for example conditioned on decoding broadcasted system information where the RS mapping for the AP/SD areas are contained, see more information “Beam selection procedure” and “Broadcast Signal Burst” described above.
   c. Specification text and communicated by dedicated signaling to the UE, e.g. using RRC signaling (e.g. system information), MAC control element or more dynamic L1 control signaling, e.g. DCI in NR.
6) Measurements by the UE according to the information on the RS resources earlier communicated. This is illustrated in block 2003 of FIG. 20A where the UE 2900 measures a signal using the number of broadcast signals (in the broadcast signal burst). The signal can be measured using RSRP, RSSI, SINR, or other signal strength measurements. The UE 2900 in some embodiments measures the signal by determining the transmission power level of beams belonging to a same sparse decoding area.
The UE 2900 in block 2005 extracts the at least one dictionary descriptor. In some embodiments, the UE extracts the at least one dictionary descriptor by extracting one of a dictionary matrix; an identifier of a dictionary matrix; a descriptor to form a dictionary with a subset of columns from a larger dictionary; or an initial states to a pre-defined pseudo-random matrix generation.
In block 2007, the UE 2900 repeats the synchronizing, measuring and extracting for a designated number of times. In some embodiments, the designated number of times is equal to a maximum number of rows in all possible dictionaries.
In block 2009, responsive to the designated number of times being met, the UE 2900 determines a dictionary descriptor to use. In some embodiments, the UE 2900 determines a dictionary descriptor to use by weighting dictionary descriptors extracted using a weight indicator and determining the dictionary descriptor from the weighted dictionary descriptors.
In block 2011, the UE 2900 determines a dictionary to use for sparse decoding based on the determined dictionary descriptor.
7) Reporting of the measurements by the UE (an example of this is described above) Thus, the UE 2900, responsive to the network node 3000 to perform the sparse decoding, transmits the signal measurements towards the network node 3000. In some embodiments, the UE 2900 also provides an indication of the determined dictionary to use.
The network node 3000, in block 2107 of FIG. 21A, receives a measurement report having measurements taken by the UE 2900 according to the RS resources communicated to the UE to measure on.
8) Sparse decoding performed at the network node (described above followed by e.g., updated AP selection based on the result). Thus, as illustrated in block 2109 of FIG. 21B, the network node 3000 performs sparse decoding based on the measurements taken by the UE.
   NOTE: All steps are not necessarily carried out in the order stated above, although several are conditioned on other steps, e.g. the UE need to know the radio resources to measure on before measurements can be conducted.

### Sparse Decoding Performed in the UE With Orthogonal RS Resources Between SD Areas

When instead the UE performs the sparse decoding, the steps described above for operations 1 through 5 are the same in this embodiment. The steps described in operations 6-8 replaced by:
6.) Acquisition of the measurement matrix/dictionary by the network, see the section of “Dictionary descriptor” above. This is illustrated by blocks 2001 to 2011 of FIG. 20A described above.
7.) Sparse decoding performed at the UE node (described above followed by e.g., updated AP selection based on the result). This is illustrated by block 2013 of FIG. 20B where the UE 2900 responsive to the UE 2900 to perform the sparse decoding, performs the sparse decoding using the signal measurements and the determined dictionary. The UE 2900 can use the results of the sparse decoding in numerous ways. For example, the UE 2900 may start using the appropriate resource in an embodiment. In other embodiments, the UE 2900 may send the results to the network node 3000.
The network node 3000, in block 2111 of FIG. 21, may receive an indication of an AP selected by the UE 2900 based on the sparse decoding.

### Sparse Decoding Performed in Network Node With Overlapping RS Resources Between SD Areas

When instead overlapping resources are used, the steps described in the first embodiment above (Sparse Decoding Performed in network node with orthogonal RS resources between SD areas) are changed according to:

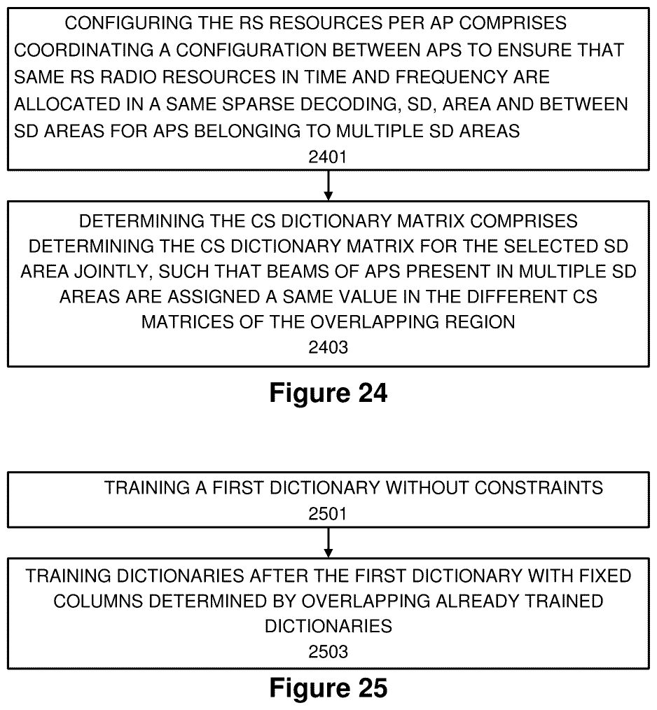

Operation 2) is replaced by:
2) Configuration of RS resources per AP, coordinating the configuration between APs to ensure that
   a. Same RS radio resources in time and frequency (e.g. resource elements (REs) in NR) are allocated (across the multiple instances of RS transmissions between APs in the same SD area, and between SD areas for APs belonging to multiple SD areas. This is illustrated in block 2401 of FIG. 24 where the network node 3000 configures the RS resources per AP by coordinating a configuration between APs to ensure that same RS radio resources in time and frequency are allocated in a same sparse decoding, SD, area and between SD areas for APs belonging to multiple SD areas. This also includes a certain level of time synchronization regarding radio resources on the air interface between AP in overlapping SD areas to ensure that the received RSs at the UE are still to a large extent overlapping to perform sequence detection (e.g. within the CP of OFDM transmissions).
   b. The same RS sequence is used by APs belonging to the same or overlapping SD areas

Operation 3) is replaced by:
3) As illustrated in block 2403 of FIG. 24, the network node 3000 determines the CS dictionary matrix for the overlapping SD area jointly, such that the beams of APs present in multiple SD areas are assigned the same value in the different CS matrices of the overlapping region. (See the procedure described above in “Dictionary training” section.)

### Sparse Decoding Performed in UE With Overlapping RS Resources Between SD Areas

When instead overlapping resources are used, the operations in the second embodiment (Sparse Decoding Performed in UE with orthogonal RS resources between SD areas) are changed according to operation 2 of the embodiment described above (Sparse Decoding Performed in Network Node with overlapping RS resources between SD areas)

It should be noted that the functions of dictionary training and also sparse decoding that is performed in the network node can be virtualized and executed in the cloud.

As described above, the dictionary training can be done sequentially, iteratively, or simultaneously.

FIG. 25 illustrates operations the network node 3000 performs when training the dictionaries sequentially. Turning to FIG. 25, in block 2501, the network node 3000 trains a first dictionary without constraints. In block 2503, the network node 3000 trains dictionaries after the first dictionary with fixed columns determined by overlapping already trained dictionaries.

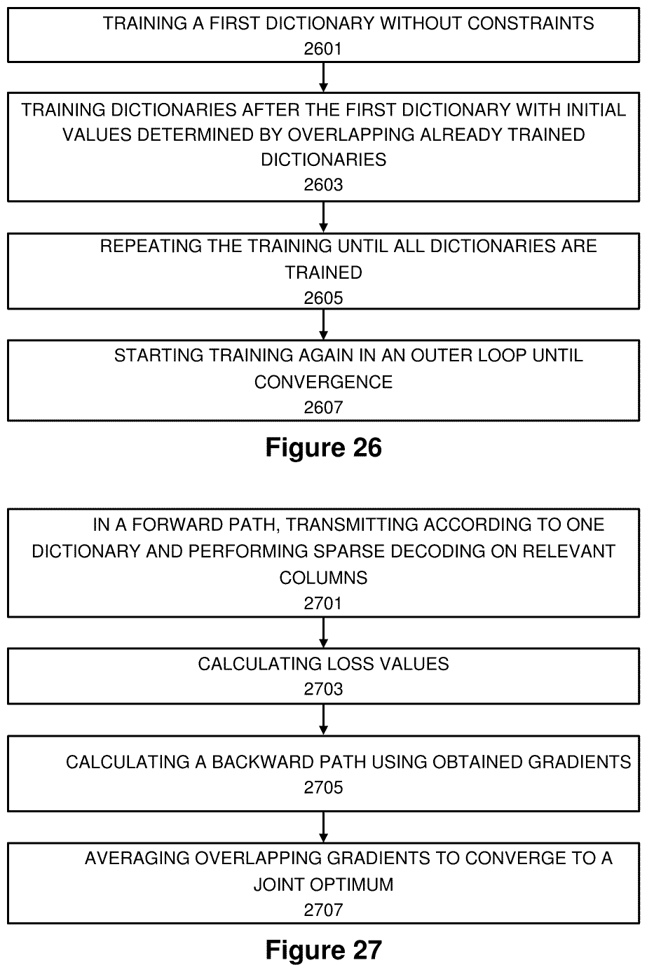

FIG. 26 illustrates operations the network node 3000 performs when training the dictionaries iteratively. Turning to FIG. 26, in block 2601, the network node 3000 trains a first dictionary without constraints. In block 2603, the network node 3000 trains dictionaries after the first dictionary with initial values determined by overlapping already trained dictionaries. In block 2605, the network node 3000 repeats the training until all dictionaries are trained. In block 2607, the network node 3000 starts training again in an outer loop until convergence.

FIG. 27 illustrates operations the network node 3000 performs when training the dictionaries simultaneously. Turning to FIG. 27, in block 2801, the network node 3000, in a forward path, transmits according to one dictionary and performs sparse decoding on relevant columns. In block 2703, the network node 3000 calculates loss values. In block 2705, the network node 3000 calculates a backward path using obtained gradients. The network node in block 2707 averages overlapping gradients to converge to a joint optimum.

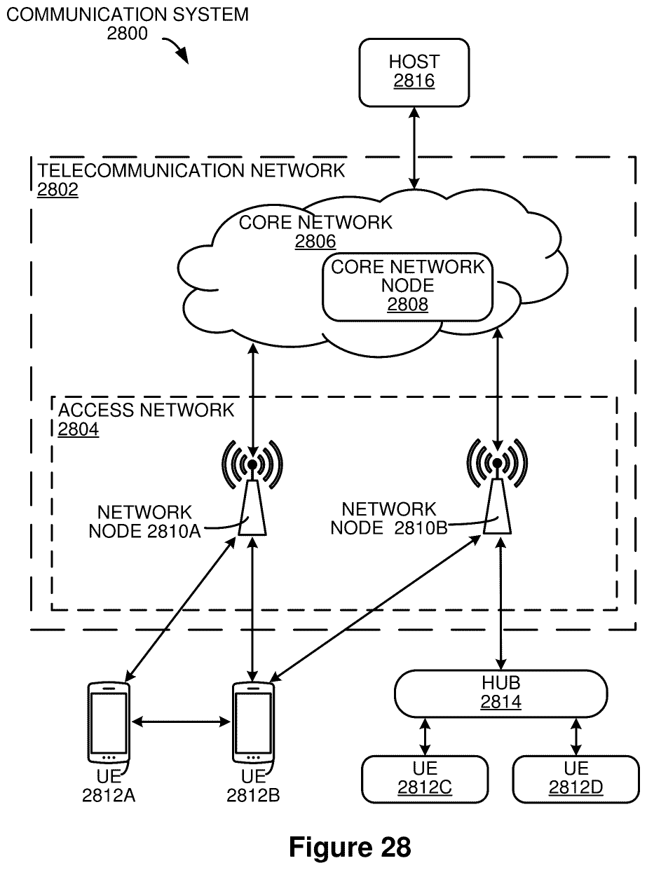

FIG. 28 shows an example of a communication system 2800 in accordance with some embodiments.

In the example, the communication system 2800 includes a telecommunication network 2802 that includes an access network 2804, such as a radio access network (RAN), and a core network 2806, which includes one or more core network nodes 2808. The access network 2804 includes one or more access network nodes, such as network nodes 2810A and 2810B (one or more of which may be generally referred to as network nodes 2810), or any other similar 3^{rd} Generation Partnership Project (3GPP) access node or non-3GPP access point. The network nodes 2810 facilitate direct or indirect connection of user equipment (UE), such as by connecting UEs 2812A, 2812B, 2812C, and 2812D (one or more of which may be generally referred to as UEs 2812) to the core network 2806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2800 may include any number of wired or wireless networks, network nodes, UEs, and/or any other components or systems that may facilitate or participate in the communication of data and/or signals whether via wired or wireless connections. The communication system 2800 may include and/or interface with any type of communication, telecommunication, data, cellular, radio network, and/or other similar type of system.

The UEs 2812 may be any of a wide variety of communication devices, including wireless devices arranged, configured, and/or operable to communicate wirelessly with the network nodes 2810 and other communication devices. Similarly, the network nodes 2810 are arranged, capable, configured, and/or operable to communicate directly or indirectly with the UEs 2812 and/or with other network nodes or equipment in the telecommunication network 2802 to enable and/or provide network access, such as wireless network access, and/or to perform other functions, such as administration in the telecommunication network 2802.

In the depicted example, the core network 2806 connects the network nodes 2810 to one or more hosts, such as host 2816. These connections may be direct or indirect via one or more intermediary networks or devices. In other examples, network nodes may be directly coupled to hosts. The core network 2806 includes one more core network nodes (e.g., core network node 2808) that are structured with hardware and software components. Features of these components may be substantially similar to those described with respect to the UEs, network nodes, and/or hosts, such that the descriptions thereof are generally applicable to the corresponding components of the core network node 2808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2816 may be under the ownership or control of a service provider other than an operator or provider of the access network 2804 and/or the telecommunication network 2802, and may be operated by the service provider or on behalf of the service provider. The host 2816 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2800 of FIG. 28 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2802 is a cellular network that implements 3GPP standardized features. Accordingly, the telecommunications network 2802 may support network slicing to provide different logical networks to different devices that are connected to the telecommunication network 2802. For example, the telecommunications network 2802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2812 are configured to transmit and/or receive information without direct human interaction. For instance, a UE may be designed to transmit information to the access network 2804 on a predetermined schedule, when triggered by an internal or external event, or in response to requests from the access network 2804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2814 communicates with the access network 2804 to facilitate indirect communication between one or more UEs (e.g., UE 2812C and/or 2812D) and network nodes (e.g., network node 2810B). In some examples, the hub 2814 may be a controller, router, content source and analytics, or any of the other communication devices described herein regarding UEs. For example, the hub 2814 may be a broadband router enabling access to the core network 2806 for the UEs. As another example, the hub 2814 may be a controller that sends commands or instructions to one or more actuators in the UEs. Commands or instructions may be received from the UEs, network nodes 2810, or by executable code, script, process, or other instructions in the hub 2814. As another example, the hub 2814 may be a data collector that acts as temporary storage for UE data and, in some embodiments, may perform analysis or other processing of the data. As another example, the hub 2814 may be a content source. For example, for a UE that is a VR headset, display, loudspeaker or other media delivery device, the hub 2814 may retrieve VR assets, video, audio, or other media or data related to sensory information via a network node, which the hub 2814 then provides to the UE either directly, after performing local processing, and/or after adding additional local content. In still another example, the hub 2814 acts as a proxy server or orchestrator for the UEs, in particular in if one or more of the UEs are low energy IoT devices.

The hub 2814 may have a constant/persistent or intermittent connection to the network node 2810B. The hub 2814 may also allow for a different communication scheme and/or schedule between the hub 2814 and UEs (e.g., UE 2812C and/or 2812D), and between the hub 2814 and the core network 2806. In other examples, the hub 2814 is connected to the core network 2806 and/or one or more UEs via a wired connection. Moreover, the hub 2814 may be configured to connect to an M2M service provider over the access network 2804 and/or to another UE over a direct connection. In some scenarios, UEs may establish a wireless connection with the network nodes 2810 while still connected via the hub 2814 via a wired or wireless connection. In some embodiments, the hub 2814 may be a dedicated hub—that is, a hub whose primary function is to route communications to/from the UEs from/to the network node 2810B. In other embodiments, the hub 2814 may be a non-dedicated hub—that is, a device which is capable of operating to route communications between the UEs and network node 2810B, but which is additionally capable of operating as a communication start and/or end point for certain data channels.

FIG. 29 shows a UE 2900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2900 includes processing circuitry 2902 that is operatively coupled via a bus 2904 to an input/output interface 2906, a power source 2908, a memory 2910, a communication interface 2912, and/or any other component, or any combination thereof. Certain UEs may utilize all or a subset of the components shown in FIG. 29. The level of integration between the components may vary from one UE to another UE. Further, certain UEs may contain multiple instances of a component, such as multiple processors, memories, transceivers, transmitters, receivers, etc.

The processing circuitry 2902 is configured to process instructions and data and may be configured to implement any sequential state machine operative to execute instructions stored as machine-readable computer programs in the memory 2910. The processing circuitry 2902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2902 may include multiple central processing units (CPUs).

In the example, the input/output interface 2906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2908 is structured as a battery or battery pack. Other types of power sources, such as an external power source (e.g., an electricity outlet), photovoltaic device, or power cell, may be used. The power source 2908 may further include power circuitry for delivering power from the power source 2908 itself, and/or an external power source, to the various parts of the UE 2900 via input circuitry or an interface such as an electrical power cable. Delivering power may be, for example, for charging of the power source 2908. Power circuitry may perform any formatting, converting, or other modification to the power from the power source 2908 to make the power suitable for the respective components of the UE 2900 to which power is supplied.

The memory 2910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2910 includes one or more application programs 2914, such as an operating system, web browser application, a widget, gadget engine, or other application, and corresponding data 2916. The memory 2910 may store, for use by the UE 2900, any of a variety of various operating systems or combinations of operating systems.

The memory 2910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2910 may allow the UE 2900 to access instructions, application programs and the like, stored on transitory or non-transitory memory media, to off-load data, or to upload data. An article of manufacture, such as one utilizing a communication system may be tangibly embodied as or in the memory 2910, which may be or comprise a device-readable storage medium.

The processing circuitry 2902 may be configured to communicate with an access network or other network using the communication interface 2912. The communication interface 2912 may comprise one or more communication subsystems and may include or be communicatively coupled to an antenna 2922. The communication interface 2912 may include one or more transceivers used to communicate, such as by communicating with one or more remote transceivers of another device capable of wireless communication (e.g., another UE or a network node in an access network). Each transceiver may include a transmitter 2918 and/or a receiver 2920 appropriate to provide network communications (e.g., optical, electrical, frequency allocations, and so forth). Moreover, the transmitter 2918 and receiver 2920 may be coupled to one or more antennas (e.g., antenna 2922) and may share circuit components, software or firmware, or alternatively be implemented separately.

In the illustrated embodiment, communication functions of the communication interface 2912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2900 shown in FIG. 29.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 30 shows a network node 3000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3000 includes a processing circuitry 3002, a memory 3004, a communication interface 3006, and a power source 3008. The network node 3000 may be composed of multiple physically separate components (e.g., a NodeB component and a RNC component, or a BTS component and a BSC component, etc.), which may each have their own respective components. In certain scenarios in which the network node 3000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 3000 may be configured to support multiple radio access technologies (RATs). In such embodiments, some components may be duplicated (e.g., separate memory 3004 for different RATs) and some components may be reused (e.g., a same antenna 3010 may be shared by different RATs). The network node 3000 may also include multiple sets of the various illustrated components for different wireless technologies integrated into network node 3000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 3000.

The processing circuitry 3002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3000 components, such as the memory 3004, to provide network node 3000 functionality.

In some embodiments, the processing circuitry 3002 includes a system on a chip (SOC). In some embodiments, the processing circuitry 3002 includes one or more of radio frequency (RF) transceiver circuitry 3012 and baseband processing circuitry 3014. In some embodiments, the radio frequency (RF) transceiver circuitry 3012 and the baseband processing circuitry 3014 may be on separate chips (or sets of chips), boards, or units, such as radio units and digital units. In alternative embodiments, part or all of RF transceiver circuitry 3012 and baseband processing circuitry 3014 may be on the same chip or set of chips, boards, or units.

The memory 3004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3002. The memory 3004 may store any suitable instructions, data, or information, including a computer program, software, an application including one or more of logic, rules, code, tables, and/or other instructions capable of being executed by the processing circuitry 3002 and utilized by the network node 3000. The memory 3004 may be used to store any calculations made by the processing circuitry 3002 and/or any data received via the communication interface 3006. In some embodiments, the processing circuitry 3002 and memory 3004 is integrated.

The communication interface 3006 is used in wired or wireless communication of signaling and/or data between a network node, access network, and/or UE. As illustrated, the communication interface 3006 comprises port(s)/terminal(s) 3016 to send and receive data, for example to and from a network over a wired connection. The communication interface 3006 also includes radio front-end circuitry 3018 that may be coupled to, or in certain embodiments a part of, the antenna 3010. Radio front-end circuitry 3018 comprises filters 3020 and amplifiers 3022. The radio front-end circuitry 3018 may be connected to an antenna 3010 and processing circuitry 3002. The radio front-end circuitry may be configured to condition signals communicated between antenna 3010 and processing circuitry 3002. The radio front-end circuitry 3018 may receive digital data that is to be sent out to other network nodes or UEs via a wireless connection. The radio front-end circuitry 3018 may convert the digital data into a radio signal having the appropriate channel and bandwidth parameters using a combination of filters 3020 and/or amplifiers 3022. The radio signal may then be transmitted via the antenna 3010. Similarly, when receiving data, the antenna 3010 may collect radio signals which are then converted into digital data by the radio front-end circuitry 3018. The digital data may be passed to the processing circuitry 3002. In other embodiments, the communication interface may comprise different components and/or different combinations of components.

In certain alternative embodiments, the network node 3000 does not include separate radio front-end circuitry 3018, instead, the processing circuitry 3002 includes radio front-end circuitry and is connected to the antenna 3010. Similarly, in some embodiments, all or some of the RF transceiver circuitry 3012 is part of the communication interface 3006. In still other embodiments, the communication interface 3006 includes one or more ports or terminals 3016, the radio front-end circuitry 3018, and the RF transceiver circuitry 3012, as part of a radio unit (not shown), and the communication interface 3006 communicates with the baseband processing circuitry 3014, which is part of a digital unit (not shown).

The antenna 3010 may include one or more antennas, or antenna arrays, configured to send and/or receive wireless signals. The antenna 3010 may be coupled to the radio front-end circuitry 3018 and may be any type of antenna capable of transmitting and receiving data and/or signals wirelessly. In certain embodiments, the antenna 3010 is separate from the network node 3000 and connectable to the network node 3000 through an interface or port.

The antenna 3010, communication interface 3006, and/or the processing circuitry 3002 may be configured to perform any receiving operations and/or certain obtaining operations described herein as being performed by the network node. Any information, data and/or signals may be received from a UE, another network node and/or any other network equipment. Similarly, the antenna 3010, the communication interface 3006, and/or the processing circuitry 3002 may be configured to perform any transmitting operations described herein as being performed by the network node. Any information, data and/or signals may be transmitted to a UE, another network node and/or any other network equipment.

The power source 3008 provides power to the various components of network node 3000 in a form suitable for the respective components (e.g., at a voltage and current level needed for each respective component). The power source 3008 may further comprise, or be coupled to, power management circuitry to supply the components of the network node 3000 with power for performing the functionality described herein. For example, the network node 3000 may be connectable to an external power source (e.g., the power grid, an electricity outlet) via an input circuitry or interface such as an electrical cable, whereby the external power source supplies power to power circuitry of the power source 3008. As a further example, the power source 3008 may comprise a source of power in the form of a battery or battery pack which is connected to, or integrated in, power circuitry. The battery may provide backup power should the external power source fail.

Embodiments of the network node 3000 may include additional components beyond those shown in FIG. 30 for providing certain aspects of the network node's functionality, including any of the functionality described herein and/or any functionality necessary to support the subject matter described herein. For example, the network node 3000 may include user interface equipment to allow input of information into the network node 3000 and to allow output of information from the network node 3000. This may allow a user to perform diagnostic, maintenance, repair, and other administrative functions for the network node 3000.

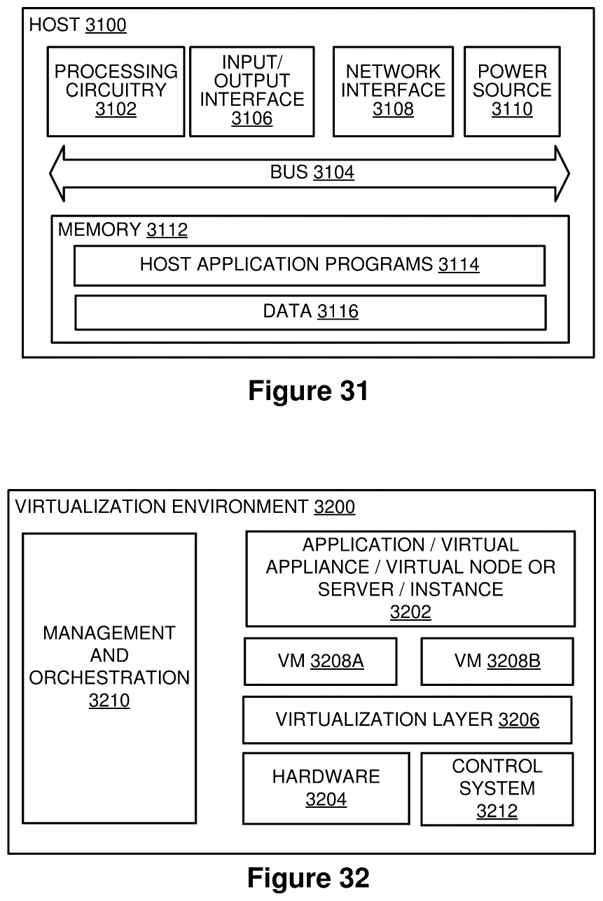

FIG. 31 is a block diagram of a host 3100, which may be an embodiment of the host 2916 of FIG. 29, in accordance with various aspects described herein. As used herein, the host 3100 may be or comprise various combinations hardware and/or software, including a standalone server, a blade server, a cloud-implemented server, a distributed server, a virtual machine, container, or processing resources in a server farm. The host 3100 may provide one or more services to one or more UEs.

The host 3100 includes processing circuitry 3102 that is operatively coupled via a bus 3104 to an input/output interface 3106, a network interface 3108, a power source 3110, and a memory 3112. Other components may be included in other embodiments. Features of these components may be substantially similar to those described with respect to the devices of previous figures, such as FIGS. 29 and 30, such that the descriptions thereof are generally applicable to the corresponding components of host 3100.

The memory 3112 may include one or more computer programs including one or more host application programs 3114 and data 3116, which may include user data, e.g., data generated by a UE for the host 3100 or data generated by the host 3100 for a UE. Embodiments of the host 3100 may utilize only a subset or all of the components shown. The host application programs 3114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 3114 may also provide for user authentication and licensing checks and may periodically report health, routes, and content availability to a central node, such as a device in or on the edge of a core network. Accordingly, the host 3100 may select and/or indicate a different host for over-the-top services for a UE. The host application programs 3114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 32 is a block diagram illustrating a virtualization environment 3200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3202 (which may alternatively be called software instances, virtual appliances, network functions, virtual nodes, virtual network functions, etc.) are run in the virtualization environment 3200 to implement some of the features, functions, and/or benefits of some of the embodiments disclosed herein.

Hardware 3204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 3206 (also referred to as hypervisors or virtual machine monitors (VMMs)), provide VMs 3208a and 3208b (one or more of which may be generally referred to as VMs 3208), and/or perform any of the functions, features and/or benefits described in relation with some embodiments described herein. The virtualization layer 3206 may present a virtual operating platform that appears like networking hardware to the VMs 3208.

The VMs 3208 comprise virtual processing, virtual memory, virtual networking or interface and virtual storage, and may be run by a corresponding virtualization layer 3206. Different embodiments of the instance of a virtual appliance 3202 may be implemented on one or more of VMs 3208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 3208 may be a software implementation of a physical machine that runs programs as if they were executing on a physical, non-virtualized machine. Each of the VMs 3208, and that part of hardware 3204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3208 on top of the hardware 3204 and corresponds to the application 3202.

Hardware 3204 may be implemented in a standalone network node with generic or specific components. Hardware 3204 may implement some functions via virtualization. Alternatively, hardware 3204 may be part of a larger cluster of hardware (e.g., such as in a data center or CPE) where many hardware nodes work together and are managed via management and orchestration 3210, which, among others, oversees lifecycle management of applications 3202. In some embodiments, hardware 3204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3212 which may alternatively be used for communication between hardware nodes and radio units.

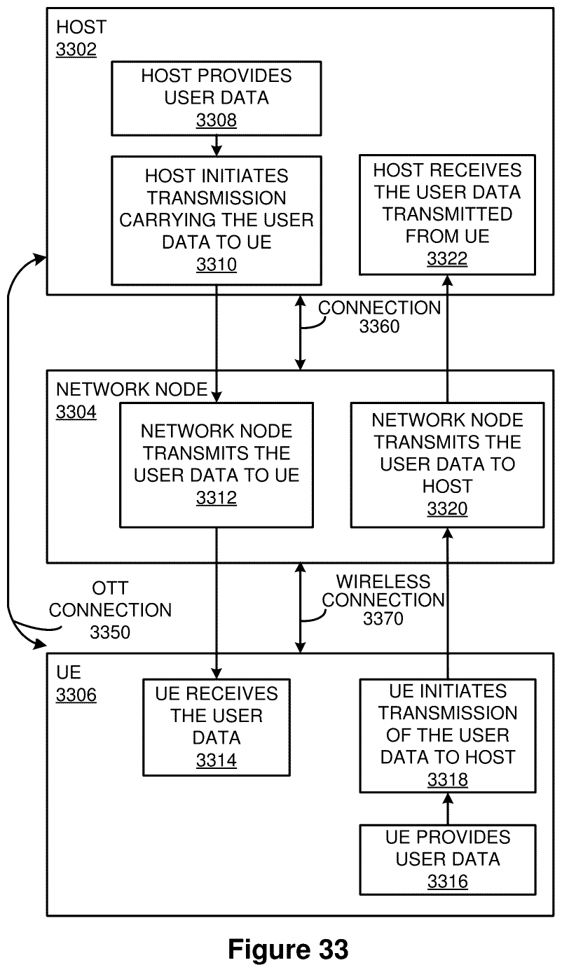

FIG. 33 shows a communication diagram of a host 3302 communicating via a network node 3304 with a UE 3306 over a partially wireless connection in accordance with some embodiments. Example implementations, in accordance with various embodiments, of the UE (such as a UE 2812A of FIG. 28 and/or UE 2900 of FIG. 29), network node (such as network node 2810a of FIG. 28 and/or network node 3000 of FIG. 30), and host (such as host 2816 of FIG. 28 and/or host 3100 of FIG. 31) discussed in the preceding paragraphs will now be described with reference to FIG. 33.

Like host 3100, embodiments of host 3302 include hardware, such as a communication interface, processing circuitry, and memory. The host 3302 also includes software, which is stored in or accessible by the host 3302 and executable by the processing circuitry. The software includes a host application that may be operable to provide a service to a remote user, such as the UE 3306 connecting via an over-the-top (OTT) connection 3350 extending between the UE 3306 and host 3302. In providing the service to the remote user, a host application may provide user data which is transmitted using the OTT connection 3350.

The network node 3304 includes hardware enabling it to communicate with the host 3302 and UE 3306. The connection 3360 may be direct or pass through a core network (like core network 2806 of FIG. 28) and/or one or more other intermediate networks, such as one or more public, private, or hosted networks. For example, an intermediate network may be a backbone network or the Internet.

The UE 3306 includes hardware and software, which is stored in or accessible by UE 3306 and executable by the UE's processing circuitry. The software includes a client application, such as a web browser or operator-specific “app” that may be operable to provide a service to a human or non-human user via UE 3306 with the support of the host 3302. In the host 3302, an executing host application may communicate with the executing client application via the OTT connection 3350 terminating at the UE 3306 and host 3302. In providing the service to the user, the UE's client application may receive request data from the host's host application and provide user data in response to the request data. The OTT connection 3350 may transfer both the request data and the user data. The UE's client application may interact with the user to generate the user data that it provides to the host application through the OTT connection 3350.

The OTT connection 3350 may extend via a connection 3360 between the host 3302 and the network node 3304 and via a wireless connection 3370 between the network node 3304 and the UE 3306 to provide the connection between the host 3302 and the UE 3306. The connection 3360 and wireless connection 3370, over which the OTT connection 3350 may be provided, have been drawn abstractly to illustrate the communication between the host 3302 and the UE 3306 via the network node 3304, without explicit reference to any intermediary devices and the precise routing of messages via these devices.

As an example of transmitting data via the OTT connection 3350, in step 3308, the host 3302 provides user data, which may be performed by executing a host application. In some embodiments, the user data is associated with a particular human user interacting with the UE 3306. In other embodiments, the user data is associated with a UE 3306 that shares data with the host 3302 without explicit human interaction. In step 3310, the host 3302 initiates a transmission carrying the user data towards the UE 3306. The host 3302 may initiate the transmission responsive to a request transmitted by the UE 3306. The request may be caused by human interaction with the UE 3306 or by operation of the client application executing on the UE 3306. The transmission may pass via the network node 3304, in accordance with the teachings of the embodiments described throughout this disclosure. Accordingly, in step 3312, the network node 3304 transmits to the UE 3306 the user data that was carried in the transmission that the host 3302 initiated, in accordance with the teachings of the embodiments described throughout this disclosure. In step 3314, the UE 3306 receives the user data carried in the transmission, which may be performed by a client application executed on the UE 3306 associated with the host application executed by the host 3302.

In some examples, the UE 3306 executes a client application which provides user data to the host 3302. The user data may be provided in reaction or response to the data received from the host 3302. Accordingly, in step 3316, the UE 3306 may provide user data, which may be performed by executing the client application. In providing the user data, the client application may further consider user input received from the user via an input/output interface of the UE 3306. Regardless of the specific manner in which the user data was provided, the UE 3306 initiates, in step 3318, transmission of the user data towards the host 3302 via the network node 3304. In step 3320, in accordance with the teachings of the embodiments described throughout this disclosure, the network node 3304 receives user data from the UE 3306 and initiates transmission of the received user data towards the host 3302. In step 3322, the host 3302 receives the user data carried in the transmission initiated by the UE 3306.

One or more of the various embodiments may improve the performance of OTT services provided to the UE 3306 using the OTT connection 3350, in which the wireless connection 3370 forms the last segment.

In an example scenario, factory status information may be collected and analyzed by the host 3302. As another example, the host 3302 may process audio and video data which may have been retrieved from a UE for use in creating maps. As another example, the host 3302 may collect and analyze real-time data to assist in controlling vehicle congestion (e.g., controlling traffic lights). As another example, the host 3302 may store surveillance video uploaded by a UE. As another example, the host 3302 may store or control access to media content such as video, audio, VR or AR which it can broadcast, multicast or unicast to UEs. As other examples, the host 3302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 3350 between the host 3302 and UE 3306, in response to variations in the measurement results. The measurement procedure and/or the network functionality for reconfiguring the OTT connection may be implemented in software and hardware of the host 3302 and/or UE 3306. In some embodiments, sensors (not shown) may be deployed in or in association with other devices through which the OTT connection 3350 passes; the sensors may participate in the measurement procedure by supplying values of the monitored quantities exemplified above, or supplying values of other physical quantities from which software may compute or estimate the monitored quantities. The reconfiguring of the OTT connection 3350 may include message format, retransmission settings, preferred routing etc.; the reconfiguring need not directly alter the operation of the network node 3304. Such procedures and functionalities may be known and practiced in the art. In certain embodiments, measurements may involve proprietary UE signaling that facilitates measurements of throughput, propagation times, latency and the like, by the host 3302. The measurements may be implemented in that software causes messages to be transmitted, in particular empty or ‘dummy’ messages, using the OTT connection 3350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method for compressed sensing based beam scanning by a user equipment, UE, in a network having a coverage area of the network decomposed into a plurality of sparse decoding areas, each sparse decoding area comprising a sub-area smaller than the coverage area and having a corresponding dictionary assigned to the sparse decoding area, the method comprising:
synchronizing to a signal burst broadcasted by a set of access points of the network in a sparse decoding area on all of a plurality of beams using varying beam power levels defined by respective dictionary descriptors, the signal burst comprising a number of broadcast signals and comprising at least one dictionary descriptor defining a mapping between the sparse decoding area and a corresponding dictionary assigned to the sparse decoding area;
measuring a signal using the number of broadcast signals;
extracting the at least one dictionary descriptor;
repeating the synchronizing, measuring and extracting for a designated number of times;
responsive to the designated number of times being met, determining a dictionary descriptor to use; and
determining a dictionary to use for sparse decoding based on the determined dictionary descriptor.

2. The method of claim 1, wherein the signal comprises one of a reference signal received power, RSRP, a received signal strength indicator, RSSI, signal to interference and noise ratio, SINR, or other signal strength measurement.

3. The method of claim 2, wherein measuring the signal using the number of broadcast signals comprises determining a transmission power level of beams belonging to a same sparse decoding area.

4. The method of claim 1, wherein the designated number of times comprises a number equal to maximum number of rows in all possible dictionaries.

5. The method of claim 1, wherein the signal burst comprises:
n Broadcast Signals; and
k resource slots for the at least one dictionary descriptor.

6. The method of claim 1, further comprising:
responsive to the UE to perform the sparse decoding, performing sparse decoding using the signal measurements and the dictionary.

7. The method of claim 1, further comprising:
responsive to a network node to perform the sparse decoding, transmitting the signal measurements towards the network node.

8. The method of claim 1, wherein at least one pair of the plurality of sparse decoding areas overlap.

9. The method of claim 1, wherein extracting the at least one dictionary descriptor comprises extracting one of:
a dictionary matrix;
an identifier of a dictionary matrix;
a descriptor to form a dictionary with a subset of columns from a larger dictionary; or
an initial state to a pre-defined pseudo-random matrix generation.

10. The method of claim 1, wherein determining a dictionary descriptor to use comprises:
weighting dictionary descriptors extracted using a weight indicator; and
determining the dictionary descriptor from the weighted dictionary descriptors.

11-24. (canceled)

25. A user equipment, UE, configured to perform operations comprising:
processing circuitry; and
memory coupled with the processing circuitry, wherein the memory includes instructions that when executed by the processing circuitry causes the UE to perform operations comprising:
synchronizing to a signal burst broadcasted by a set of access points of the network in a sparse decoding area on all of a plurality of beams using varying beam power levels defined by respective dictionary descriptors, the signal burst comprising a number of broadcast signals and comprising at least one dictionary descriptor defining a mapping between the sparse decoding area and a corresponding dictionary assigned to the sparse decoding area;
measuring a signal using the number of broadcast signals;
extracting the at least one dictionary descriptor;
repeating the synchronizing, measuring and extracting for a designated number of times;
responsive to the designated number of times being met, determining a dictionary descriptor to use; and
determining a dictionary to use for sparse decoding based on the determined dictionary descriptor.

26. The UE of claim 25, wherein the signal comprises one of a reference signal received power, RSRP, a received signal strength indicator, RSSI, signal to interference and noise ratio, SINR, or other signal strength measurement.

27-34. (canceled)
